(19) United States
(12) Patent Application Publication
(10) Pub. No.: US 2024/0123950 A1
(43) Pub. Date: Apr. 18, 2024

(54) VEHICLE MOVING APPARATUS

(71) Applicant: HL MANDO CORPORATION, Pyeongtaek-si (KR)

(72) Inventors: Jeong Jae PARK, Seoul (KR); Seung Tae BAEK, Seongnam-si (KR); WanKyu CHOI, Seongnam-si (KR); Joon-Kyu SONG, Seongnam-si (KR); Seong Ho CHOI, Anyang-si (KR)

(73) Assignee: HL MANDO CORPORATION, Pyeongtaek-si (KR)

(21) Appl. No.: 18/379,305

(22) Filed: Oct. 12, 2023

(30) Foreign Application Priority Data
Oct. 13, 2022 (KR) 10-2022-0131031

(51) Int. Cl. B60S 13/00

(52) U.S. Cl. CPC B60S 13/00

(57) ABSTRACT

A vehicle moving apparatus may include a housing extending in a first direction; an elevator coupled to the housing to be movable in the first direction and another direction opposite thereto, extending in a third direction and being inserted to be drawable into an underside space of a vehicle, and configured to lift or lower a wheel of the vehicle; and a wheel assembly coupled to the elevator and configured to move the housing and the elevator in a direction toward the vehicle or in a direction opposite the vehicle, wherein the wheel assembly includes a wheel rotatably provided with a vertical direction as an axis, and configured to movably support the elevator; and an actuator coupled to the wheel and configured to provide power for rotating the wheel, wherein the wheel is rotatable such that a diameter of the wheel is aligned between the first and third directions.

### CROSS-REFERENCE TO RELATED APPLICATION

The present application claims the benefit of priority to Korean Patent Application No. 10-2022-0131031, filed on Oct. 13, 2022 in the Korean Intellectual Property Office, the entire disclosure of which is incorporated herein by reference.

### TECHNICAL FIELD

The present disclosure relates to a vehicle moving apparatus, and more particularly, to a vehicle moving apparatus having a structure capable of moving a vehicle while minimizing the number of required actuators.

### BACKGROUND

Recently, technologies for driving a vehicle without user intervention have been introduced. These technologies, which are referred to as autonomous driving, provide opportunities for beginners in driving or long-distance drivers to drive more comfortably and safely.

In addition, in driving a vehicle, a task performed as frequently as driving may be referred to as parking. Recently, technologies for performing autonomous parking as well as technologies for simply assisting parking have been introduced, contributing to driver convenience.

However, the above technologies have a limitation in that they can be utilized only in a state where a driver gets on or is positioned adjacent to a host vehicle. That is, when the driver finishes parking the vehicle and moves to another location, the vehicle does not move from the parked location.

Meanwhile, due to the concentration of the population in the city center and the consequent increase in the number of vehicles, a number of serious parking difficulties are occurring. Although various technologies described above have been developed for the driver's convenience, it is never easy to solve the parking difficulties itself.

In particular, when a vehicle is previously parked, the vehicle cannot be moved and parked until the driver returns. Accordingly, in order to park a new vehicle, a driver must be summoned again to move the corresponding vehicle. Accordingly, a dispute may occur between drivers, and inconvenience to other drivers may be caused.

Accordingly, recently, technologies for moving previously parked vehicles have been introduced. These technologies can improve space utilization by directly moving a previously parked vehicle. In general, an apparatus to which these technologies are applied may be named a “parking robot”.

The parking robot is configured to move toward the vehicle, elevate the vehicle, and move with the vehicle lifted. To this end, the parking robot requires a power source for moving and a power source for lifting and lowering the vehicle, respectively. Considering that a vehicle has a high weight of 1 ton or more, the power source provided in the parking robot is equipped with a high specification, which can cause an increase in the price of the parking robot.

In a conventional robot parking apparatus and a handling method thereof, a structure of the robot parking apparatus may be capable of efficiently utilizing a parking space by accommodating a vehicle inside a container and moving the accommodated vehicle in a three-dimensional space.

However, such a conventional robot parking apparatus and handling method thereof premise that the robot parking apparatus is provided as a huge structure capable of accommodating a plurality of vehicles. That is, the conventional apparatus and method do not provide a method for moving a vehicle parked in a limited space without a separate structure.

In another conventional parking management robot capable of autonomous driving, a structure is provided to change the parking position of a vehicle by moving a plate on which the vehicle is seated using a drive wheel apparatus formed thereunder.

However, this conventional parking management robot premises that the vehicle is parked on the parking management robot, in which case a method for moving a vehicle parked on a bare site where a separate structure is not provided.

In addition, these conventional technologies must be formed at least in a size larger than that of a vehicle. Therefore, additional space is required in order to provide a parking apparatus or a parking management robot according to the above technologies.

Furthermore, the conventional parking apparatus or parking management robot must be provided in the form of a one-to-one correspondence with the vehicle. That is, in order to park a plurality of vehicles, a parking apparatus or a parking management robot must also be provided in a corresponding number.

Therefore, the above conventional parking apparatus or parking management robot do not provide a method for efficiently utilizing a limited space and a method for achieving economic benefits of a service operator.

### SUMMARY

### Technical Problem

The present disclosure is to solve the above problems, and is directed to providing a vehicle moving apparatus having a structure capable of efficiently utilizing a limited space.

The present disclosure is also directed to providing a vehicle moving apparatus having a structure capable of moving a plurality of vehicles by being provided with a single number of vehicle moving apparatuses.

The present disclosure is also directed to providing a vehicle moving apparatus having a structure capable of miniaturization.

The present disclosure is also directed to providing a vehicle moving apparatus having a structure in which the number of actuators required for driving can be minimized.

The present disclosure is also directed to providing a vehicle moving apparatus having a simple structure and easy maintenance.

The present disclosure is also directed to providing a vehicle moving apparatus having a structure in which a vehicle can be easily lifted and lowered, and moved.

The problems of the present disclosure are not limited to those mentioned above, and other problems not mentioned will be clearly understood by those of ordinary skill in the art from the following description.

### Technical Solution

According to an aspect of the present disclosure, provided is a vehicle moving apparatus, including a housing extending in a first direction; an elevator coupled to the housing to be movable in the first direction and a second direction opposite thereto, extending in a third direction and being inserted to be drawable into an underside space of a vehicle, and configured to lift and lower a wheel of the vehicle; and a wheel assembly coupled to the elevator and configured to move the housing and the elevator in a direction toward the vehicle or in a direction opposite the vehicle, wherein the wheel assembly includes a first wheel rotatably provided with a vertical direction as an axis, and configured to movably support the elevator; and an actuator coupled to the first wheel and configured to provide power for rotating the first wheel, wherein the first wheel is rotatable about the vertical direction such that a diameter of the first wheel is aligned between the first direction and the third direction.

In this case, in the vehicle moving apparatus, the actuator may include a first actuator coupled to the first wheel and configured to provide power for rotating the first wheel with a vertical direction as an axis.

In addition, in the vehicle moving apparatus, the wheel assembly may include a gear coupled to the first actuator and the first wheel, respectively, and configured to deliver the power provided by the first actuator to the first wheel.

In this case, in the vehicle moving apparatus, the gear may include a first gear coupled to the first wheel; and a second gear gear-fitted with the first gear and coupled to the first actuator.

In addition, in the vehicle moving apparatus, the first wheel assembly may include a gear accommodating part configured to accommodate the gear and coupled to the elevator.

In this case, in the vehicle moving apparatus, the actuator may include a second actuator coupled to the first wheel and configured to provide power for rotating the first wheel with a horizontal direction as an axis.

In addition, in the vehicle moving apparatus, when the first actuator is operated, the first wheel may be rotated with a vertical direction as an axis such that a diameter of the first wheel is aligned between the first direction and the third direction, and when the second actuator is operated, the first wheel may be rotated with a horizontal direction as an axis such that the first wheel is movable toward the first or second direction.

In this case, in the vehicle moving apparatus, when the first wheel is rotated such that a diameter of the first wheel is aligned in the third direction and then the second actuator is operated, the elevator may be inserted into an underside space of the vehicle or be drawn out of the underside space of the vehicle.

In addition, in the vehicle moving apparatus, the elevator may include a pair of arms extending along the third direction, and when the first wheel is rotated such that a diameter of the first wheel is aligned along the first direction and then the second actuator is operated, the pair of arms may be moved in a direction toward each other or a direction away from each other.

In this case, in the vehicle moving apparatus, when the pair of arms are moved toward each other, the pair of arms may be in contact with the first wheel, and when the pair of arms are further moved toward each other, an outer circumferential surface of the first wheel may be partially supported on the pair of arms to lift the first wheel.

According to another aspect of the present disclosure, provided is a vehicle moving apparatus, including a housing extending in a longitudinal direction of a vehicle; an elevator coupled to the housing and movable along an extension direction of the housing, and extending in a width direction of the vehicle and being insertable into or drawable from an underside space of the vehicle; a wheel assembly positioned adjacent to a lower side of one end of the elevator in the extension direction, and movably supporting the housing and the elevator; and a supporter positioned adjacent to a lower side of the other end of the elevator in the extension direction, and movably supporting the elevator, wherein the elevator includes an arm extending in a width direction of the vehicle ang being insertable into or drawable from an underside space of the vehicle to lift and lower the vehicle; a housing coupler coupled to the one end of the arm in an extension direction and movably coupled to the housing; and a wheel coupler coupled to the housing coupler and rotatably coupled to the wheel assembly.

In this case, in the vehicle moving apparatus, the arm may include an arm body extending in a width direction of the vehicle; a coupling plate positioned at the one end of the arm body and extending at a predetermined angle with the arm body to be coupled to the housing coupler; and a reinforcing rib extending along a surface of the coupling plate and coupled to the arm body and the coupling plate to maintain a coupling state of the arm body and the coupling plate.

In addition, in the vehicle moving apparatus, the elevator may include a first elevator located to be biased to one side of the housing in the extension direction of the elevator; and a second elevator spaced apart from the first elevator in the extension direction of the housing and located to be biased to the one side of the housing in the extension direction of the elevator.

In this case, in the vehicle moving apparatus, the first elevator and the second elevator may be disposed to face each other with a wheel provided in the vehicle interposed therebetween, and when the first elevator and the second elevator are moved toward each other, the wheel may be supported by the arm, and when the first elevator and the second elevator are further moved toward each other, the wheel may be lifted by the arm.

In addition, in the vehicle moving apparatus, the arm may include a first arm provided in the first elevator; and a second arm provided in the second elevator, wherein the first arm and the second arm include rollers disposed at respective edges facing each other and configured to be in contact with a wheel provided in the vehicle to be rolled.

In this case, in the vehicle moving apparatus, the rollers of the first arm and the second arm may be disposed in parallel to each other so as to be adjacent to each other along an extension direction of the housing, and a length of each roller may be greater than or equal to a width of the wheel.

In addition, in the vehicle moving apparatus, each roller may be provided in plural, and the plurality of rollers may be disposed to be spaced apart from each other along an extension direction of the arms, and the plurality of rollers may be configured to be respectively in contact with a pair of the wheels disposed on the left side and the right side of the vehicle, respectively.

In this case, in the vehicle moving apparatus, the arm may include an arm body extending in a width direction of the vehicle; and a friction pad positioned on an upper surface of the arm body, extending along an extension direction of the arm body, and configured to increase frictional force by contact with a wheel provided in the vehicle.

In addition, in the vehicle moving apparatus, the friction pad may be provided in plural, and the plurality of friction pads may be disposed to be spaced apart from each other along an extension direction of the arm body, and the plurality of friction pads may be configured to be respectively in contact with a pair of the wheels disposed on the left side and the right side of the vehicle, respectively.

In this case, in the vehicle moving apparatus, the supporter may include a support body coupled to the other end of the arm; a caster supporting the support body and rotatably provided with a vertical direction as an axis; and a rotating plate positioned between the support body and the caster, coupled to the support body, and rotatably coupled to the caster.

### Advantageous Effects

According to the above configuration, the vehicle moving apparatus according to the embodiment of the present disclosure can efficiently utilize a limited space.

In addition, according to the above configuration, a single number of vehicle moving apparatuses according to the embodiment of the present disclosure can be provided to move a plurality of vehicles.

In addition, according to the above configuration, the vehicle moving apparatus according to the embodiment of the present disclosure can be miniaturized.

In addition, according to the above configuration, the number of actuators required for driving can be minimized in the vehicle moving apparatus according to the embodiment of the present disclosure.

In addition, according to the above configuration, the vehicle moving apparatus according to the embodiment of the present disclosure can be simplified in structure and easily maintained.

In addition, according to the above configuration, the vehicle moving apparatus according to the embodiment of the present disclosure can easily lift and lower and move the vehicle.

Advantageous effects of the present disclosure are not limited to the above-described effects, and should be understood to include all effects that can be inferred from the configuration of the disclosure described in the detailed description or claims of the present disclosure.

### BRIEF DESCRIPTION OF THE DRAWINGS

FIGS. 1 and 2 are perspective views illustrating a vehicle moving apparatus according to an embodiment of the present disclosure.

FIG. 3 is a plan view illustrating the vehicle moving apparatus of FIG. 1.

FIG. 4 is a bottom view illustrating the vehicle moving apparatus of FIG. 1.

FIGS. 5 and 6 are exploded perspective views illustrating a configuration of the vehicle moving apparatus of FIG. 1.

FIG. 7 is an exploded perspective view illustrating a joint provided in the vehicle moving apparatus of FIG. 1.

FIG. 8 is a perspective view illustrating a housing provided in the vehicle moving apparatus of FIG. 1.

FIG. 9 is an exploded perspective view illustrating an elevator provided in the vehicle moving apparatus of FIG. 1.

FIG. 10 is a perspective view illustrating an arm provided in the elevator of FIG. 9.

FIGS. 11 and 12 are perspective views illustrating a housing coupler provided in the elevator of FIG. 9.

FIG. 13 is a perspective view illustrating a wheel coupler provided in the elevator of FIG. 9.

FIGS. 14, 15, and 16 are perspective views illustrating a wheel assembly provided in the vehicle moving apparatus of FIG. 1.

FIG. 17 is an exploded perspective view illustrating a supporter provided in the vehicle moving apparatus of FIG. 1.

FIGS. 18(a) and 18(b) are right side views illustrating a rotation of a moving part provided in the vehicle moving apparatus of FIG. 1.

FIGS. 19 and 20 are use state views illustrating a process of moving a vehicle by a vehicle moving apparatus according to an embodiment of the present disclosure.

### DETAILED DESCRIPTION OF THE EMBODIMENTS

Hereinafter, exemplary embodiments of the present disclosure will be described in detail so that those of ordinary skill in the art can readily implement the present disclosure with reference to the accompanying drawings. The present disclosure may be embodied in many different forms and are not limited to the embodiments set forth herein. In the drawings, parts unrelated to the description are omitted for clarity of description of the present disclosure, and throughout the specification, like reference numerals denote like elements.

Terms and words used in the present specification and claims should not be construed as limited to their usual or dictionary definition, and they should be interpreted as a meaning and concept consistent with the technical idea of the present disclosure based on the principle that inventors may appropriately define the terms and concept in order to describe their own disclosure in the best way.

Accordingly, the embodiments described in the present specification and the configurations shown in the drawings correspond to preferred embodiments of the present disclosure, and do not represent all the technical idea of the present disclosure, so the configurations may have various examples of equivalent and modification that can replace them at the time of filing the present disclosure.

In the following description, in order to clarify the features of the present disclosure, descriptions of some components may be omitted.

The term “communication” used in the following description means that one or more members are connected to each other so as to be in fluid communication. In an embodiment, communication may be formed by a member such as a conduit, a pipe, a tubing, or the like.

The term “applying an electric current” used in the following description means that one or more members are connected to each other so as to transmit a current or an electric signal. In an embodiment, the applying an electric current may be formed in a wired form by a wire member or the like or in a wireless form such as Bluetooth, Wi-Fi, RFID, or the like.

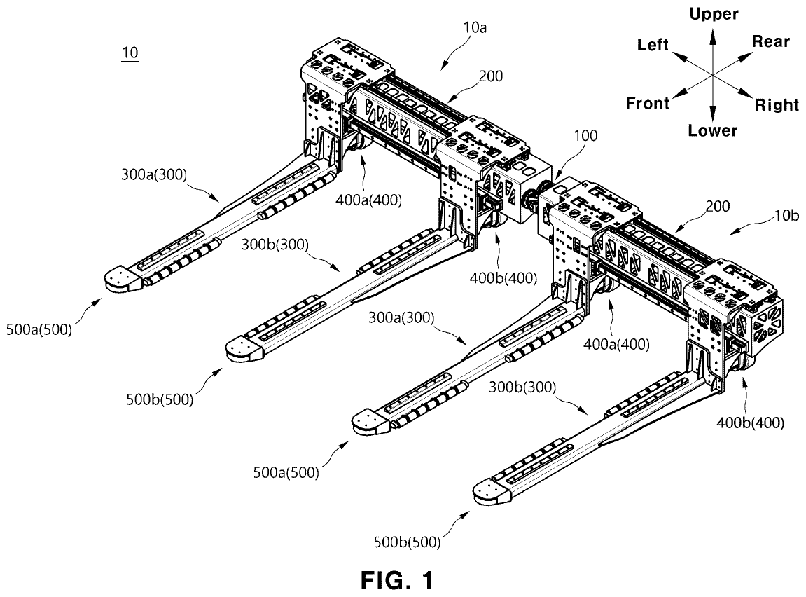

The terms “upper side”, “lower side”, “left side”, “right side”, “front side”, and “rear side” used in the following description will be understood with reference to the coordinate system shown in FIG. 1.

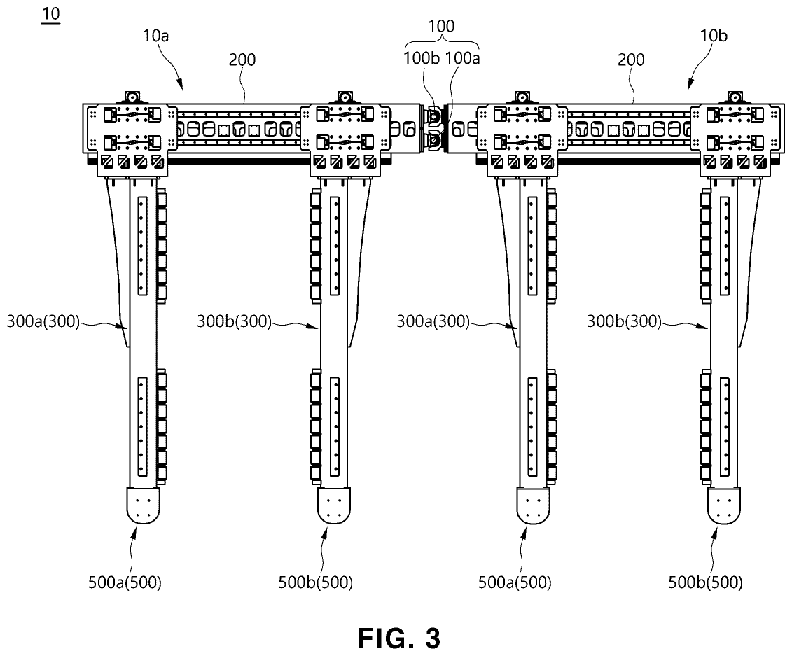

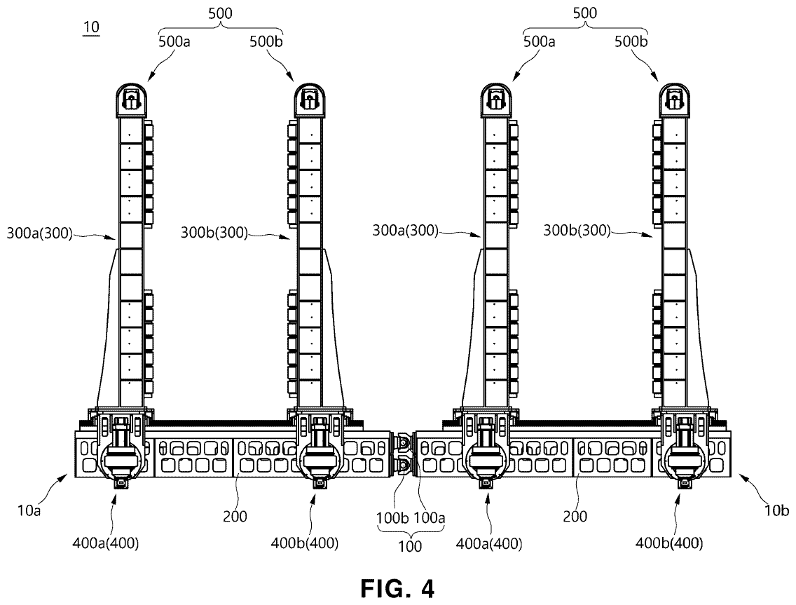

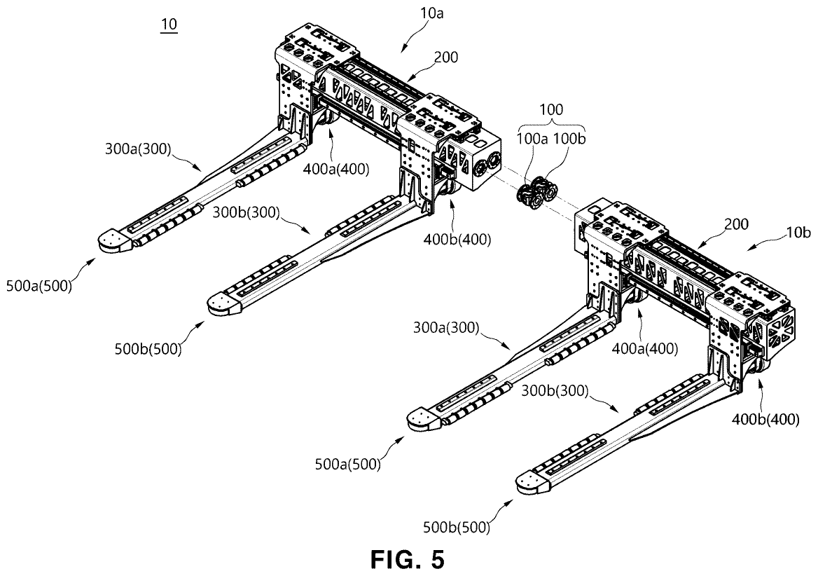

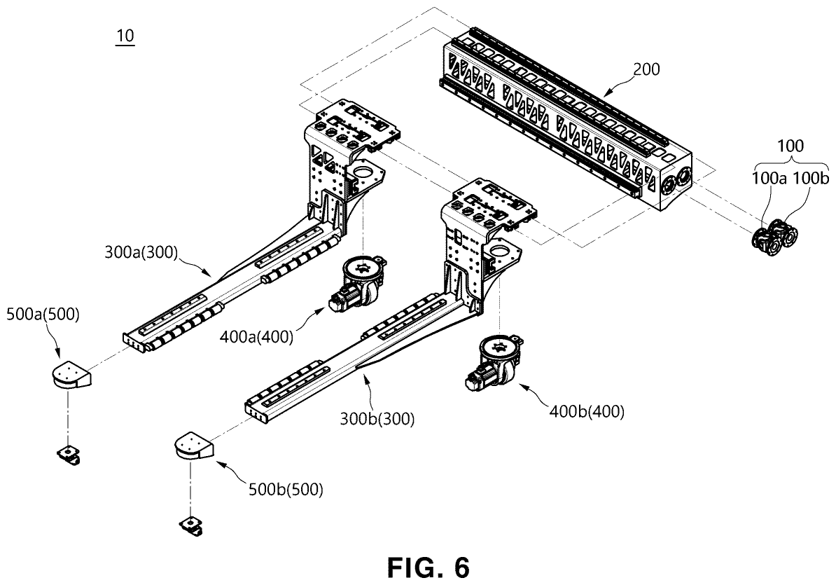

Referring to FIGS. 1 to 6, a vehicle moving apparatus 10 according to an embodiment of the present disclosure is disclosed. The vehicle moving apparatus 10 may move a vehicle V after lifting wheels W provided in the vehicle V.

The vehicle moving apparatus 10 according to an embodiment of the present disclosure is configured to support both the front side wheels W and the rear side wheels W of the vehicle V. Accordingly, the vehicle moving apparatus 10 may be moved while stably supporting the vehicle V.

In addition, the vehicle moving apparatus 10 according to an embodiment of the present disclosure is operated using a single actuator. Specifically, the vehicle moving apparatus 10 may move a configuration for supporting the vehicle V using a single actuator. In addition, the vehicle moving apparatus 10 may be moved using the single actuator.

Therefore, as the number of actuators required is reduced, the vehicle moving apparatus 10 according to an embodiment of the present disclosure may reduce manufacturing costs and may simplify an operation mechanism. Accordingly, the movement of the vehicle moving apparatus 10 itself, the process of supporting the vehicle V, and the process of moving while supporting the vehicle V may be reliably performed.

The vehicle moving apparatus 10 according to an embodiment of the present disclosure may be operated automatically. In other words, the vehicle moving apparatus 10 may be operated according to a preset routine without manual operation by an operator or the like. Alternatively, the vehicle moving apparatus 10 may be operated by a remote control device such as a remote controller. That is, in an embodiment, the vehicle moving apparatus 10 may be provided in the form of a robot.

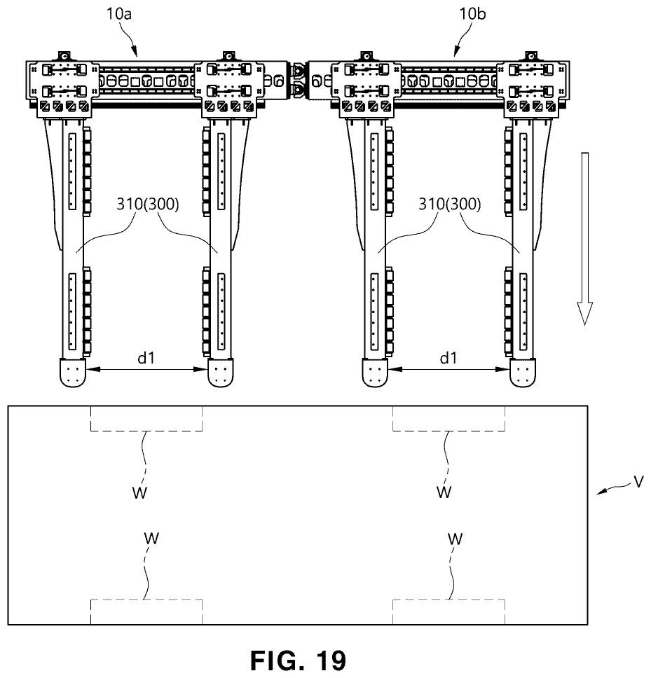

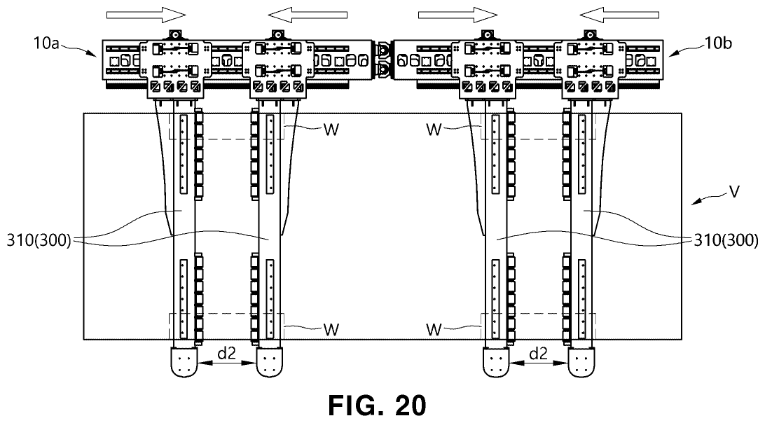

The vehicle moving apparatus 10 may be formed to have a smaller size compared to the vehicle V. As shown in FIGS. 19 to 20, the vehicle moving apparatus 10 may extend by a distance at which the front side wheels W and the rear side wheels W provided in the vehicle V are spaced apart. In addition, the vehicle moving apparatus 10 may be formed to have a height lower than that of the vehicle V, so that it may stably support the wheels W located at the lower side of the vehicle V.

The vehicle moving apparatus 10 may be moved in a horizontal direction. In the illustrated embodiment, the vehicle moving apparatus 10 may be moved in a front-rear direction or a left-right direction. In this case, the vehicle moving apparatus 10 may be moved in a front-rear direction or a left-right direction by a single actuator (i.e., an actuator 430 to be described later).

Therefore, the process of moving the vehicle moving apparatus 10 adjacent to the vehicle V and the process of moving the vehicle moving apparatus 10 adjacent to the wheel W can be performed by a single actuator, thereby improving operation reliability and reducing manufacturing costs.

The vehicle moving apparatus 10 may lift and lower a vehicle V. This is achieved by an elevator 300 to be described later supporting the wheel W of the vehicle V from the lower side.

A plurality of vehicle moving apparatuses 10 may be provided. The plurality of vehicle moving apparatuses 10 may be detachably coupled to each other to support and move the vehicle V together. In the illustrated embodiment, the vehicle moving apparatus 10 includes a first vehicle moving apparatus 10a located on the left side and a second vehicle moving apparatus 10b located on the right side.

The first vehicle moving apparatus 10a and the second vehicle moving apparatus 10b are detachably coupled by a joint 100. Accordingly, the first vehicle moving apparatus 10a and the second vehicle moving apparatus 10b may be moved together to lift and lower the vehicle V.

As will be described later, the joint 100 is provided to be rotatable in a horizontal direction and a vertical direction. Accordingly, the first vehicle moving apparatus 10a and the second vehicle moving apparatus 10b may be rotated in a horizontal direction and a vertical direction with respect to each other.

The first vehicle moving apparatus 10a and the second vehicle moving apparatus 10b have some different positions coupled to the joint 100, but the other configurations and operation structures are the same. Accordingly, in the following description, the first vehicle moving apparatus 10a and the second vehicle moving apparatus 10b will be collectively referred to as the “vehicle moving apparatus 10”.

In the illustrated embodiment, the vehicle moving apparatus 10 includes a joint 100, a housing 200, an elevator 300, and a wheel assembly 400.

The joint 100 movably couples the first vehicle moving apparatus 10a and the second vehicle moving apparatus 10b. The joint 100 is removably coupled to the first vehicle moving apparatus 10a and the second vehicle moving apparatus 10b, respectively.

The joint 100 is positioned between the first vehicle moving apparatus 10a and the second vehicle moving apparatus 10b.

The joint 100 is coupled to a joint coupler 220 of the housing 200. In the illustrated embodiment, the left portion of the joint 100 is coupled to the joint coupler 220 formed in the right portion of the housing 200 of the first vehicle moving apparatus 10a, and the right portion of the joint 100 is coupled to the joint coupler 220 formed in the left portion of the housing 200 of the second vehicle moving apparatus 10b.

The joint 100 may be configured to be rotatable in a horizontal direction and a vertical direction. Therefore, the first vehicle moving apparatus 10a and the second vehicle moving apparatus 10b coupled by the joint 100 are also rotatably coupled in a horizontal direction and a vertical direction with respect to each other. That is, in an embodiment, the joint 100 may be provided as a universal joint.

Accordingly, even when unevenness is formed or a slope exists on the ground, the vehicle moving apparatus 10 may be stably moved.

A plurality of joints 100 may be provided. The plurality of joints 100 may be coupled to a plurality of joint couplers 220 provided respectively in the first vehicle moving apparatus 10a and the second vehicle moving apparatus 10b, respectively. In the illustrated embodiment, two joints 100 are provided, including a first joint 100a positioned on the front side and a second joint 100b positioned on the rear side.

In the above embodiment, the plurality of joints 100a and 100b may stably couple the first vehicle moving apparatus 10a and the second vehicle moving apparatus 10b. In addition, as the plurality of joints 100a and 100b are disposed to be spaced apart from each other in a front-rear direction, a shaking in the horizontal direction of the first vehicle moving apparatus 10a and the second vehicle moving apparatus 10b may be minimized.

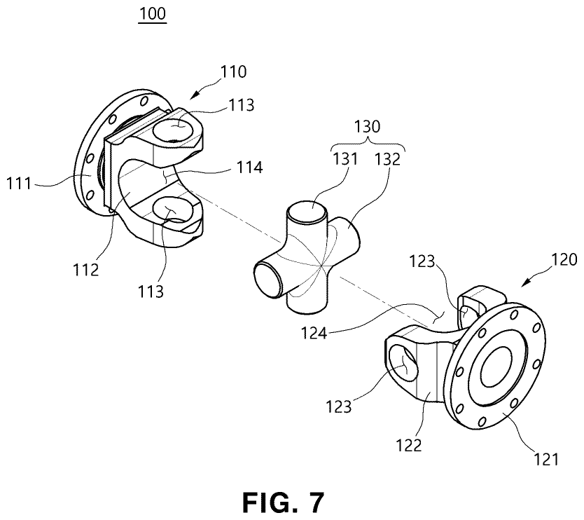

In the embodiment shown in FIG. 7, the joint 100 includes a first joint body 110, a second joint body 120, and a coupler 130.

The first joint body 110 forms one portion of the joint 100. In the illustrated embodiment, the first joint body 110 forms a left portion of the joint 100.

The first joint body 110 is coupled to the joint coupler 220 of the first vehicle moving apparatus 10a positioned on the left side. In an embodiment, the first joint body 110 may be detachably coupled to the joint coupler 220.

The first joint body 110 is coupled to the second joint body 120. Specifically, the first joint body 110 is rotatably coupled with the second joint body 120 by the coupler 130.

The first joint body 110 is coupled to the coupler 130. The first joint body 110 is rotatably coupled to the coupler 130 in a horizontal direction. In other words, the first joint body 110 may be horizontally rotated clockwise or counterclockwise with a first coupling arm 131 of the coupler 130 as an axis.

In the illustrated embodiment, the first joint body 110 includes a first flange 111, a first joint arm 112, a first coupling hole 113, and a first accommodating part 114.

The first flange 111 is a portion where the first joint body 110 is coupled to the housing 200 of the first vehicle moving apparatus 10a. The first flange 111 forms one side of the portions of the first joint body 110 toward the first vehicle moving apparatus 10a, i.e., a left portion in the illustrated embodiment.

The first flange 111 may have any shape capable of being coupled to the joint coupler 220 of the housing 200. In the illustrated embodiment, the first flange 111 has a circular cross-section and is a disc shape having a thickness in the left and right directions.

In the above embodiment, a plurality of through holes may be formed adjacent to the outer circumference of the first flange 111. A fastener (not shown) for coupling the first flange 111 to the joint coupler 220 may be coupled through the through hole.

The first joint arm 112, the first coupling hole 113, and the first accommodating part 114 are positioned at a portion of the first flange 111 facing the second flange 121 or the coupler 130, i.e., at a right portion in the illustrated embodiment.

The first joint arm 112 is a portion where the first joint body 110 is coupled to the coupler 130. The first joint arm 112 is continuous with the first flange 111. The first joint arm 112 extends from one side toward the coupler 130, i.e., from the left side in the illustrated embodiment.

The first joint arm 112 may be divided into a plurality of parts. In the illustrated embodiment, the first joint arm 112 includes a first portion coupled to the first flange 111 and extending in the up-down direction, and a pair of second portions each continuous with the first portion and spaced apart from each other in the up-down direction and extending toward the coupler 130. The pair of second portions may be coupled to the coupler 130, respectively.

A first coupling hole 113 is formed in the pair of second portions of the first joint arm 112.

The first coupling hole 113 is a space through which the coupler 130 is rotatably penetrated. The first coupling hole 113 is formed to pass through the first joint arm 112 in the thickness direction, i.e., in the up-down direction in the illustrated embodiment. In the illustrated embodiment, the first coupling hole 113 has a circular cross-section and is a cylindrical space extending in the up-down direction. The shape of the first coupling hole 113 may be changed according to the shape of the first coupling arm 131 of the coupler 130.

A plurality of first coupling holes 113 may be formed. The plurality of first coupling holes 113 may be formed in the pair of second portions of the first joint arm 112, respectively. In the illustrated embodiment, a total of two first coupling holes 113 are formed, one in the upper side second portion and one in the lower side second portion, respectively. In the above embodiment, the first coupling holes 113 formed respectively in the pair of second portions may be disposed to have the same central axis.

A space formed between the plurality of first joint arms 112 is defined as a first accommodating part 114.

The first accommodating part 114 is a space for rotatably accommodating the coupler 130. The first accommodating part 114 is partially surrounded by the first portion and the pair of second portions of the first joint arm 112.

One side of each side of the first accommodating part 114 toward the coupler 130, i.e., the right side in the illustrated embodiment, is formed open. In addition, among each side of the first accommodating part 114, the directions in which the first coupling arm 131 of the coupler 130 extends, i.e., the front side and the rear side in the illustrated embodiment, are also formed open.

Accordingly, the coupler 130 may be rotated clockwise or counterclockwise in the horizontal direction while being accommodated in the first accommodating part 114.

The first joint body 110 is rotatably coupled with the second joint body 120 by the coupler 130.

The second joint body 120 forms the other portion of the joint 100. In the illustrated embodiment, the second joint body 120 forms a right portion of the joint 100.

The second joint body 120 is coupled to the joint coupler 220 of the second vehicle moving apparatus 10b positioned on the right side. In an embodiment, the second joint body 120 may be detachably coupled to the joint coupler 220.

The second joint body 120 is coupled to the first joint body 110. Specifically, the second joint body 120 is rotatably coupled with the first joint body 110 by the coupler 130.

The second joint body 120 is coupled to the coupler 130. The second joint body 120 is rotatably coupled to the coupler 130 in a horizontal direction. In other words, the second joint body 120 may be vertically rotated clockwise or counterclockwise with a second coupling arm 132 of the coupler 130 as an axis.

In the illustrated embodiment, the second joint body 120 includes a second flange 121, a second joint arm 122, a second coupling hole 123, and a second accommodating part 124.

The second flange 121 is a portion where the second joint body 120 is coupled to the housing 200 of the second vehicle moving apparatus 10b. The second flange 121 forms one side of the portions of the second joint body 120 toward the second vehicle moving apparatus 10b, i.e., a right portion in the illustrated embodiment.

The second flange 121 may have any shape capable of being coupled to the joint coupler 220 of the housing 200. In the illustrated embodiment, the second flange 121 has a circular cross-section and is a disc shape having a thickness in the left and right directions.

In the above embodiment, a plurality of through holes may be formed adjacent to the outer circumference of the second flange 121. A fastener (not shown) for coupling the second flange 121 to the joint coupler 220 may be coupled through the through hole.

The second joint arm 122, the second coupling hole 123, and the second accommodating part 124 are positioned at a portion of the second flange 121 facing the second flange 121 or the coupler 130, i.e., at a left portion in the illustrated embodiment.

The second joint arm 122 is a portion where the second joint body 120 is coupled to the coupler 130. The second joint arm 122 is continuous with the second flange 121. The second joint arm 122 extends from one side toward the coupler 130, i.e., from the left side in the illustrated embodiment.

The second joint arm 122 may be divided into a plurality of parts. In the illustrated embodiment, the second joint arm 122 includes a first portion coupled to the second flange 121 and extending in the front-rear direction, and a pair of second portions each continuous with the first portion and spaced apart from each other in the front-rear direction and extending toward the coupler 130. The pair of second portions may be coupled to the coupler 130, respectively.

A second coupling hole 123 is formed in the pair of second portions of the second joint arm 122.

The second coupling hole 123 is a space through which the coupler 130 is rotatably penetrated. The second coupling hole 123 is formed to pass through the second joint arm 122 in the thickness direction, i.e., in the front-rear direction in the illustrated embodiment. In the illustrated embodiment, the second coupling hole 123 has a circular cross-section and is a cylindrical space extending in the front-rear direction. The shape of the second coupling hole 123 may be changed according to the shape of the second coupling arm 132 of the coupler 130.

A plurality of second coupling holes 123 may be formed. The plurality of second coupling holes 123 may be formed in the pair of second portions of the second joint arm 122, respectively. In the illustrated embodiment, a total of two second coupling holes 123 are formed, one in the front side second portion and one in the rear side second portion, respectively. In the above embodiment, the second coupling holes 123 formed respectively in the pair of second portions may be disposed to have the same central axis.

A space formed between the plurality of second joint arms 122 is defined as a second accommodating part 124.

The second accommodating part 124 is a space for rotatably accommodating the coupler 130. The second accommodating part 124 is partially surrounded by the first portion and the pair of second portions of the second joint arm 122.

One side of each side of the second accommodating part 124 toward the coupler 130, i.e., the left side in the illustrated embodiment, is formed open. In addition, among each side of the second accommodating part 124, the directions in which the second coupling arm 132 of the coupler 130 extends, i.e., the front side and the rear side in the illustrated embodiment, are also formed open.

Accordingly, the coupler 130 may be rotated clockwise or counterclockwise in the horizontal direction while being accommodated in the second accommodating part 124.

The coupler 130 rotatably couples the first joint body 110 and the second joint body 120. Therefore, the first vehicle moving apparatus 10a and the second vehicle moving apparatus 10b coupled by the coupler 130 are also rotatably coupled in a horizontal direction or a vertical direction with respect to each other.

The coupler 130 is coupled to the first joint body 110. Specifically, the coupler 130 is accommodated in the first accommodating part 114 and rotatably inserted and coupled to the first coupling hole 113.

The coupler 130 is coupled to the second joint body 120. Specifically, the coupler 130 is accommodated in the second accommodating part 124 and rotatably inserted and coupled to the second coupling hole 123.

The coupler 130 may be divided into a plurality of parts. One part of the plurality of parts may be rotatably coupled with the first joint body 110, and the other part may be rotatably coupled with the second joint body 120.

In the illustrated embodiment, the coupler 130 includes a first coupling arm 131 rotatably coupled with the first joint body 110 and a second coupling arm 132 rotatably coupled with the second joint body 120.

The first coupling arm 131 forms one portion of the coupler 130. The first coupling arm 131 extends in a direction in which the pair of second portions of the first joint arm 112 are spaced apart from each other, i.e., in the up-down direction in the illustrated embodiment. The first coupling arm 131 is accommodated in the first accommodating part 114 and rotatably inserted and coupled to the first coupling hole 113.

The first coupling arm 131 is continuous with the second coupling arm 132.

The second coupling arm 132 forms the other portion of the coupler 130. The second coupling arm 132 extends in a direction in which the pair of second portions of the second joint arm 122 are spaced apart from each other, i.e., in a front-rear direction in the illustrated embodiment. The second coupling arm 132 is accommodated in the second accommodating part 124 and rotatably inserted and coupled to the second coupling hole 123.

The first coupling arm 131 and the second coupling arm 132 may extend at a predetermined angle. In an embodiment, the first coupling arm 131 and the second coupling arm 132 extend perpendicular to each other. In the above embodiment, it can be said that the coupler 130 is formed in a cross shape.

The joint 100 is coupled to the housing 200.

The housing 200 forms a body of the vehicle moving apparatus 10. The housing 200 may be coupled to the joint 100 and moved together.

As described above, a plurality of vehicle moving apparatuses 10 are provided, including a first vehicle moving apparatus 10a and a second vehicle moving apparatus 10b. The housing 200 provided in the first vehicle moving apparatus 10a and the housing 200 provided in the second vehicle moving apparatus 10b may be coupled by the joint 100 to each other to be movable relative to each other.

The housing 200 moveably supports the elevator 300. As will be described later, the elevator 300 includes a housing coupler 320 movably coupled to the housing 200. The elevator 300 may be slidably moved along the extension direction of the housing 200 while being coupled to the housing 200.

The housing 200 extends in one direction, i.e., the left-right direction in the illustrated embodiment. In an embodiment, the extension direction of the housing 200 may be the same as the direction in which the first vehicle moving apparatus 10a and the second vehicle moving apparatus 10b are spaced apart from each other.

The housing 200 may be any shape capable of accommodating components for controlling the vehicle moving apparatus 10 therein and movably supporting the elevator 300. In the illustrated embodiment, the housing 200 has a quadrangular cross-section and has a quadrangular column shape extending in the left and right directions.

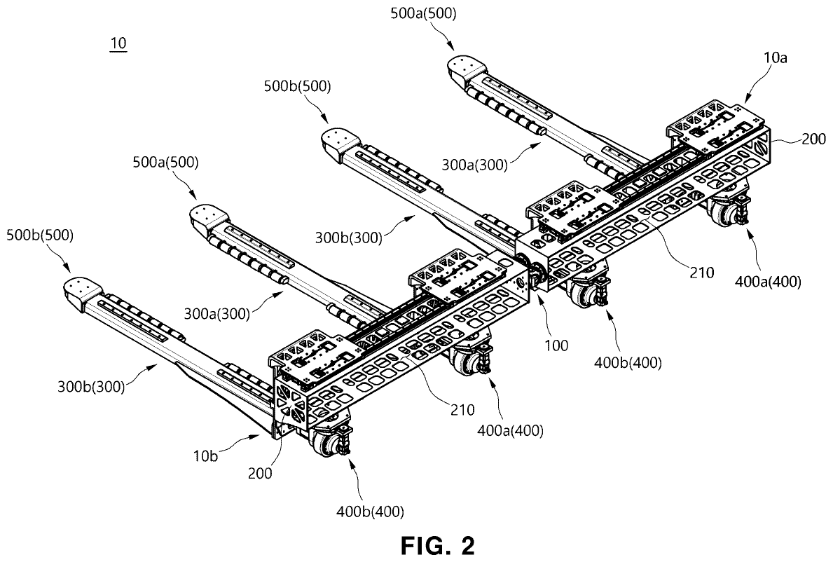

Among each side of the housing 200, an opposite side of the elevator 300 in the direction in which an arm 310 extends, i.e., the rear side in the illustrated embodiment, is formed open (see FIG. 2). Various components for controlling the vehicle moving apparatus 10 may be accommodated inside the housing 200 through the opposite side.

A plurality of openings and a plurality of ribs surrounding the plurality of openings are formed on the surface surrounding the space of the housing 200. Accordingly, the rigidity of the housing 200 may be reinforced, and each component accommodated in the space of the housing 200 may be effectively cooled. Further, the weight of the housing 200 may be reduced, and thus power required for operation of the vehicle moving apparatus 10 may be reduced.

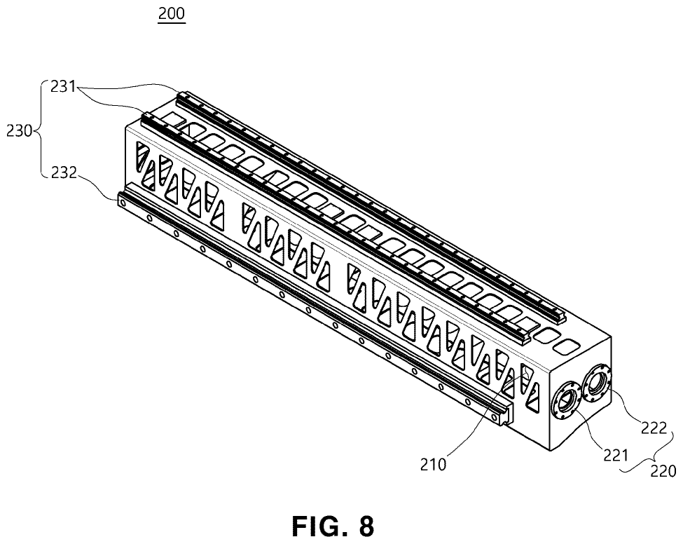

In the embodiment shown in FIG. 8, the housing 200 includes a housing space 210, a joint coupler 220, and a guide rail 230.

The housing space 210 is a space formed inside the housing 200. The housing space 210 may accommodate various components for operating the vehicle moving apparatus 10. In an embodiment, the housing space 210 may accommodate a power source (not shown) for supplying power to an actuator 430 to be described later, a controller (not shown) for controlling the actuator 430, and the like.

The housing space 210 communicates with the outside. One side of the housing space 210, i.e., the rear side in the illustrated embodiment, is formed open and communicates with the outside. As described above, various components for controlling the vehicle moving apparatus 10 may be accommodated in the housing space 210 through the rear side.

In addition, the housing space 210 communicates with the outside through the plurality of openings formed on the surface of the housing 200. Accordingly, the various components accommodated in the housing space 210 may be effectively cooled.

The housing space 210 may be formed in a shape corresponding to the shape of the housing 200. In the illustrated embodiment, the housing space 210 has a quadrangular cross-section and is a quadrangular column-shaped space extending in the left and right directions.

The joint coupler 220 is coupled to the first flange 111 and the second flange 121 of the joint 100. The joint coupler 220 may be detachably coupled to the first and second flanges 111 and 121. In an embodiment, the joint coupler 220 may be coupled with a fastener (not shown) penetratingly coupled to the first and second flanges 111 and 121.

The joint coupler 220 is located at one end of the ends of the housing 200 in the extension direction toward the joint 100. That is, the joint coupler 220 provided in the first vehicle moving apparatus 10a is located on the right end surface of the housing 200. Likewise, the joint coupler 220 provided in the second vehicle moving apparatus 10b is located on the left end surface of the housing 200.

In other words, the joint couplers 220 provided in the first and second vehicle moving apparatuses 10a and 10b are disposed to face each other with the joint 100 interposed therebetween.

The joint coupler 220 may be formed in a shape corresponding to the first and second flanges 111 and 121. In the illustrated embodiment, the joint coupler 220 has a circular cross-section and is formed to have a thickness in the left and right directions.

A plurality of joint couplers 220 may be provided. The plurality of joint couplers 220 may be disposed adjacent to each other and coupled to the plurality of joints 100, respectively.

In the illustrated embodiment, two joint couplers 220 are provided, including a first joint coupler 221 positioned on the front side and a second joint coupler 222 positioned on the rear side. The first joint coupler 221 is coupled to the first joint 100a. The second joint coupler 222 is coupled to the second joint 100b.

As the first joint 100a and the second joint 100b are disposed in the front-rear direction, a relative movement distance of the first vehicle moving apparatus 10a and the second vehicle moving apparatus 10b respectively coupled to the joint 100 may be limited in the front-rear direction. Accordingly, the vehicle moving apparatus 10 may be stably moved and stably support the wheel W of the vehicle V.

The guide rail 230 moveably supports the elevator 300. The guide rail 230 is located outside the housing 200. The guide rail 230 is formed to protrude outward compared to the outer surface of the housing 200.

The guide rail 230 extends along the extension direction of the housing 200. In the illustrated embodiment, the guide rail 230 extends in the left-right direction. In this case, the extension length of the guide rail 230 may be shorter than the extension length of the housing 200. Accordingly, each end of the guide rail 230 in the extended direction may be positioned inside compared to each end of the housing 200 in the extension direction.

The guide rail 230 is coupled to the housing coupler 320 of the elevator 300. Specifically, the guide rail 230 moveably supports guide clamps 323 and 324 provided in the housing coupler 320. The elevator 300 may be moved along the guide rail 230 in an extension direction thereof, i.e., left or right in the illustrated embodiment.

A plurality of guide rails 230 may be provided. The plurality of guide rails 230 may be disposed on different surfaces of the housing 200, respectively, and may moveably support the elevator 300 at a plurality of points.

In the illustrated embodiment, the guide rail 230 includes a first guide rail 231 disposed on an upper side surface of the housing 200 and a second guide rail 232 disposed on the front side surface of the housing 200.

The first guide rail 231 is disposed on one surface of the housing 200, i.e., on an upper surface in the illustrated embodiment. The first guide rail 231 is movably coupled to a first guide clamp 323 provided in the elevator 300.

A plurality of first guide rails 231 may be provided. The plurality of first guide rails 231 may be spaced apart from each other and may extend in parallel. In the illustrated embodiment, two first guide rails 231 are provided and are spaced apart from each other in the extension direction, i.e., the front-rear direction, of the arm 310 of the elevator 300.

That is, the first guide rail 231 may movably support the first guide clamp 323 at a plurality of points. Accordingly, the coupling of the first guide rail 231 and the first guide clamp 323 can be stably maintained.

The second guide rail 232 is disposed on the other surface of the housing 200, i.e., on the front side surface in the illustrated embodiment. The second guide rail 232 is movably coupled to a second guide clamp 324 provided in the elevator 300.

In the illustrated embodiment, a single second guide rail 232 is provided and located biased below the other surface of the housing 200. Alternatively, a plurality of second guide rails 232 may be provided and disposed to be spaced apart from each other in the height direction of the other surface of the housing 200.

The elevator 300 substantially performs a function of lifting and lowering the vehicle V including the wheel W and the wheel W. The elevator 300 is configured to be movable in a direction towards the vehicle V, i.e. the front side in the illustrated embodiment and in a direction opposite to the vehicle V, i.e. the rear side in the illustrated embodiment. This is achieved by the wheel assembly 400 to be described later.

The elevator 300 may elevate the vehicle V including the wheel Wand the wheel W. In addition, the elevator 300 may be moved while the vehicle V is elevated. This is also achieved by the wheel assembly 400 to be described later.

That is, power for driving the elevator 300 may be provided from a single wheel assembly 400. Accordingly, a separate actuator for driving the elevator 300 is not required, and thus, energy efficiency may be improved and manufacturing costs may be reduced.

The elevator 300 is coupled to the housing 200. The elevator 300 is movably coupled to the guide rail 230 of the housing 200. The elevator 300 is coupled to the housing 200 to be movable in the extension direction of the guide rail 230, i.e., in the left-right direction in the illustrated embodiment.

The elevator 300 is coupled to the wheel assembly 400. The elevator 300 rotatably supports the wheel assembly 400. Accordingly, wheels 420 of the wheel assembly 400 may be rotated with the vertical direction as an axis, and thus the movement direction of the vehicle moving apparatus 10 or the movement direction of the elevator 300 may be changed.

A plurality of elevators 300 may be provided. The plurality of elevators 300 may be coupled to a single housing 200 and configured to elevate the wheels W together. In the illustrated embodiment, the elevator 300 is provided in a pair, including a first elevator 300a disposed to be biased to the left side of the housing 200 and a second elevator 300b disposed to be biased to the right side of the housing 200.

Accordingly, it will be understood that the first vehicle moving apparatus 10a and the second vehicle moving apparatus 10b have a pair of elevators 300a and 300b, respectively, so that the vehicle moving apparatus 10 includes a total of two pairs of elevators 300.

In this case, the distance between the pair of elevators 300a and 300b provided in the first vehicle moving apparatus 10a and the pair of elevators 300a and 300b provided in the second vehicle moving apparatus 10b may be determined according to the distance between the front side wheel W and the rear side wheel W provided in the vehicle V.

That is, the pair of elevators 300a and 300b respectively provided in the first vehicle moving apparatus 10a and the second vehicle moving apparatus 10b may elevate the front side wheel W and the rear side wheel W, respectively.

In an initial state in which the vehicle moving apparatus 10 approaches the vehicle V, the first elevator 300a and the second elevator 300b may be disposed to face each other with the wheel W interposed therebetween. In the above state, the first elevator 300a and the second elevator 300b may be moved toward each other and may be in contact with the wheel W. When the first elevator 300a and the second elevator 300b are further moved toward each other, the wheel W may be lifted and spaced apart from the ground.

In the above state, the vehicle moving apparatus 10 may be moved with the vehicle V lifted to move the vehicle V.

Likewise, in the above state, when the first elevator 300a and the second elevator 300b are moved to be farther from each other, the wheel W may be lowered and may be in contact with the ground. In the above state, the first elevator 300a and the second elevator 300b may be further moved to be farther from each other and spaced apart from the wheel W.

The first elevator 300a and the second elevator 300b are configured to elevate the wheel W together. The first elevator 300a and the second elevator 300b have some difference in shapes thereof, and each of the configurations and functions are the same, and thus, in the overlapping descriptions below, the first elevator 300a and the second elevator 300b are collectively referred to as “elevator 300”.

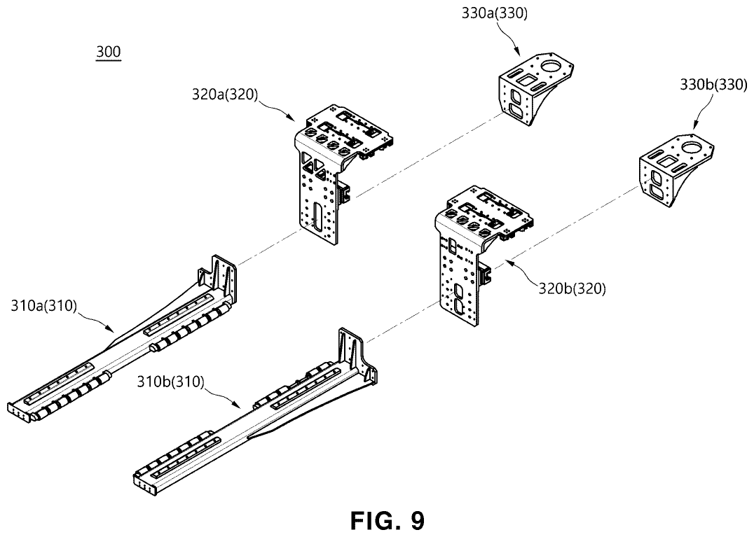

In the embodiment shown in FIGS. 9 to 13, the elevator 300 includes an arm 310, a housing coupler 320, and a wheel coupler 330.

The arm 310 is moved from a radially outward side of the wheel W to a radially inward side to support the wheel W The arm 310 extends in a direction towards the vehicle V, i.e., the front side in the illustrated embodiment.

The extension length of the arm 310 may be determined according to the length of the width of the vehicle V. Specifically, the arm 310 is inserted through the underside of the vehicle V from the left or right side of the vehicle V. In this case, the arm 310 may simultaneously elevate a pair of wheels W provided at the front side of the vehicle V and a pair of wheels W positioned at the rear side of the vehicle V.

Therefore, one end of a portion of the arm 310 in the extension direction, i.e., the front side end in the illustrated embodiment, may be positioned adjacent to the front side wheel W of the vehicle V. Likewise, the other end of the portion of the arm 310 in the extension direction, i.e., the rear side end in the illustrated embodiment, may be positioned adjacent to the rear side wheel W of the vehicle V.

Therefore, it will be understood that the extension length of the arm 310 is formed longer than the distance between the pair of front side wheels W or the distance between the pair of rear side wheels W.

A plurality of arms 310 may be provided. The plurality of arms 310 may form a portion of the first elevator 300a and the second elevator 300b, respectively. In the illustrated embodiment, the arm 310 is provided in a pair, including a first arm 310a provided in the first elevator 300a and a second arm 310b provided in the second elevator 300b.

As described above, the pair of arms 310, i.e., the first arm 310a and the second arm 310b may lift or lower the wheel W The arm 310 is coupled to the housing coupler 320. In the illustrated embodiment, one end of the ends of the arm 310 in the extension direction toward the housing 200, i.e., the rear side end, is coupled to the housing coupler 320.

The arm 310 is coupled to a supporter 500. In the illustrated embodiment, the other end opposite to the housing 200 of the ends in the extension direction of the arm 310, i.e., the front side end, is coupled to the supporter 500.

In the illustrated embodiment, the arm 310 includes an arm body 311, a coupling plate 312, a reinforcing rib 313, a coupling end 314, a roller 315, and a friction pad 316.

The arm body 311 forms a body of the arm 310. The arm body 311 may extend in the width direction of the vehicle V to support a pair of wheels W at the same time.

The arm body 311 may be any shape capable of lifting or lowering the wheel W. In the illustrated embodiment, the arm body 311 has a length in the front-rear direction and is provided in a quadrangular plate shape having a thickness in the up-down direction.

The coupling plate 312 and the reinforcing rib 313 are located at one end of the ends of the arm body 311 in the extension direction toward the housing 200, i.e., at the rear side end in the illustrated embodiment. The coupling end 314 is located at the other end opposite to the housing 200 of the ends of the arm body 311 in the extension direction, i.e., at the front side end in the illustrated embodiment.

The roller 315 is formed at one edge, where the pair of arms 310a and 310b face each other, of the edges of the arm body 311. The friction pad 316 is provided at one side opposite to the ground of the surfaces of the arm body 311, i.e., at the upper side surface in the illustrated embodiment.

The coupling plate 312 is a portion where the arm 310 is coupled to the housing coupler 320. The coupling plate 312 is located at the one end of the arm body 311 in the extension direction, i.e., at the rear side in the illustrated embodiment.

The coupling plate 312 extends at a predetermined angle with the upper surface of the arm body 311. In the illustrated embodiment, the coupling plate 312 is formed to extend in a direction opposite to the ground, that is, upwardly, perpendicular to the upper surface of the arm body 311.

The coupling plate 312 is coupled to the second plate 322 of the housing coupler 320. A separate fastener (not shown) may be provided for the coupling.

The reinforcing rib 313 is formed on the coupling plate 312.

The reinforcing rib 313 is formed on the coupling plate 312 to reinforce the rigidity of the arm body 311 and the coupling plate 312. When the arm body 311 lifts the wheel W, a force is applied in a direction in which the arm body 311 and the coupling plate 312 are spread out from each other, that is, in a direction in which the predetermined angle is increased.

In this case, the reinforcing rib 313 is coupled to the arm body 311 and the coupling plate 312, respectively, and maintains their coupling state.

The reinforcing rib 313 extends in the same direction as the extension direction of the coupling plate 312. In the illustrated embodiment, the reinforcing rib 313 extends in the up-down direction. One end of the ends of the reinforcing rib 313 in the extension direction toward the ground, i.e., the lower end in the illustrated embodiment, is continuous with the upper surface of the arm body 311.

A plurality of reinforcing ribs 313 may be formed. The plurality of reinforcing ribs 313 may be disposed to be spaced apart from each other along the width direction of the coupling plate 312. In the illustrated embodiment, three reinforcing ribs 313 are formed and disposed to be spaced apart from each other in the left and right directions.

In this case, the extension length of the plurality of reinforcing ribs 313 may be changed according to the shape of the coupling plate 312. In the illustrated embodiment, the extension length of the outer reinforcing rib 313 is formed to be shorter than the extension length of the inner reinforcing rib 313.

The coupling end 314 is coupled to the supporter 500. The coupling end 314 is located at the other end of the arm body 311 in the extension direction, i.e., at the front side in the illustrated embodiment.

The coupling end 314 is coupled with a support body 510 of the supporter 500. As will be described later, the supporter 500 includes a caster 530 supporting the other end of the arm body 311 at the front side in the illustrated embodiment. By means of the coupling end 314, the front side end of the arm body 311 may be supported by the caster 530.

The roller 315 reduces frictional force between the arm 310 moved toward the wheel W and the wheel W As the arm 310 is moved toward the wheel W, frictional force may be generated between the surface of the arm 310 and the wheel W. In this case, in order to further move the arm 310 toward the inside of the wheel W, power exceeding the frictional force is required.

In this case, the roller 315 is positioned between the wheel W and the arm body 311, thereby reducing the frictional force generated between the wheel W and the arm body 311. In other words, the roller 315 may be rotated in contact with the wheel W, such that the arm body 311 may be easily inserted into the underside of the wheel W and lift the wheel W.

The roller 315 is rotatably coupled to the arm body 311. Therefore, as the arm 310 is moved toward the wheel W, the roller 315 may be rotated in contact with the wheel W and reduce the frictional force.

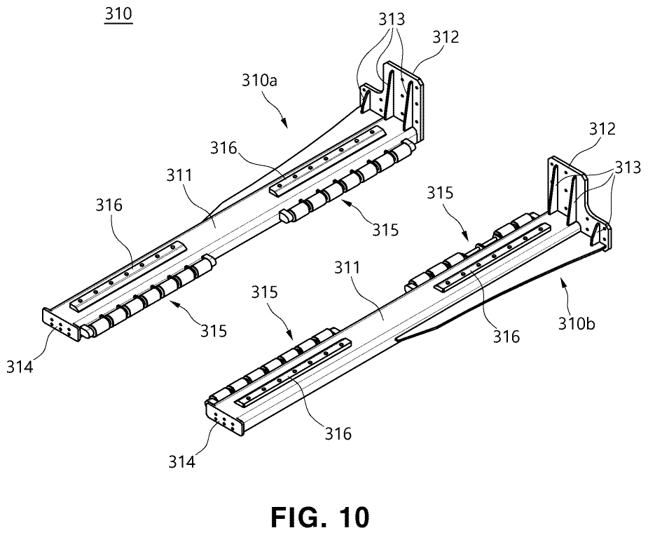

The roller 315 is formed on an inner surface of the surfaces of the arm body 311. That is, as shown in FIG. 10, the first arm 310a and the second arm 310b are spaced apart from each other to form a space in which the wheel W is positioned therebetween. In this case, the roller 315 provided in the first arm 310a is located on the right side surface of the arm body 311, and the roller 315 provided in the second arm 310b is located on the left side surface of the arm body 311.

Therefore, the rollers 315 provided in the first arm 310a and the second arm 310b are disposed to face each other.

A plurality of rollers 315 may be provided. The plurality of rollers 315 may be disposed parallel to each other along the extension direction of the arm body 311. The plurality of rollers 315 may reduce frictional force by being in contact with a single number of wheels W provided in the vehicle V. In the illustrated embodiment, seven rollers 315 are provided and arranged side by side along the front-rear direction.

In this case, the sum of the lengths of the plurality of rollers 315 arranged side by side may be equal to or greater than the length of the width of the wheel W Therefore, the plurality of rollers 315 may be evenly in contact with the outer circumferential surface of the wheel W and may reduce frictional force.

The roller 315 may be provided in a plurality of groups. The plurality of groups of rollers 315 may be spaced apart from each other along the extension direction of the arm body 311 and may be configured to be in contact with a pair of wheels W, respectively. In the illustrated embodiment, the roller 315 may be provided in a pair of groups along the front-rear direction to minimize friction with the wheel W provided on the left side of the vehicle V and the wheel W provided on the right side of the vehicle V, respectively.

The friction pad 316 increases the frictional force with the lifted wheel W, thereby stably maintaining the state in which the wheel W is supported by the arm 310. Due to the frictional force applied by the friction pad 316, the wheel W seated on the arm 310 is not separated arbitrarily by sliding or rolling.

The friction pad 316 may be formed of any material capable of increasing frictional force with a contacted member. In an embodiment, the friction pad 316 may be formed of a rubber or silicone material.

The friction pad 316 is formed on one opposite to the ground of the surfaces of the arm body 311, i.e., on the upper side surface in the illustrated embodiment. The friction pad 316 extends along the extension direction of the arm body 311. In the illustrated embodiment, the friction pad 316 extends in the front-rear direction.

In this case, the extension length of the friction pad 316 may be equal to or greater than the length of the width of the wheel W Therefore, the friction pad 316 may uniformly contact the outer circumferential surface of the wheel W and provide frictional force to prevent the wheel W from being separated.

A plurality of friction pads 316 may be provided. The plurality of friction pads 316 may be disposed to be spaced apart from each other along the extension direction of the arm body 311. In the illustrated embodiment, two friction pads 316 are provided and located biased to the front side and the rear side of the arm body 311, respectively.

Meanwhile, the friction pad 316 may be disposed adjacent to the roller 315. That is, it may be disposed at the same position along the extension direction of the arm body 311, i.e., the front-rear direction in the illustrated embodiment. In addition, the extension length of the friction pad 316 may be equal to the sum of the lengths of the plurality of rollers 315 provided in one group.

Therefore, the frictional force between the wheel W and the arm 310 may be reduced by the roller 315 during the process of moving the arm 310 between the lower side of the wheel W and the ground and lifting the wheel W. Accordingly, the arm 310 may easily lift the wheel W In addition, after the wheel W is lifted, the frictional force between the wheel W and the arm 310 may be increased by the friction pad 316. Accordingly, the lifted wheel W is not arbitrarily separated from the arm 310.

The housing coupler 320 is a portion where the elevator 300 is coupled to the housing 200. The housing coupler 320 is movably coupled to the housing 200. As described above, the housing coupler 320 is coupled to the housing 200 so as to be movable in the extension direction of the housing 200, i.e., in the left-right direction in the illustrated embodiment.

Therefore, the elevator 300 may be moved along the extension direction of the housing 200 and may be moved toward the wheel W or may be moved in a direction opposite to the wheel W.

The housing coupler 320 is coupled to the arm 310. The housing coupler 320 may be fixedly coupled to the arm 310 to support the arm 310. In the illustrated embodiment, the housing coupler 320 is coupled to the coupling plate 312 of the arm 310.

The housing coupler 320 is coupled to the wheel coupler 330. The housing coupler 320 may be fixedly coupled to the wheel coupler 330 to support the wheel coupler 330 and the wheel assembly 400 coupled to the wheel coupler 330.

The housing coupler 320 may be any shape that may be movably coupled to the housing 200 and coupled to the arm 310 and the wheel coupler 330, respectively. In the illustrated embodiment, the housing coupler 320 has an angle shape including two bent surfaces.

A plurality of housing couplers 320 may be provided. The plurality of housing couplers 320 may be coupled to the housing 200, the arm 310, and the wheel coupler 330, respectively.

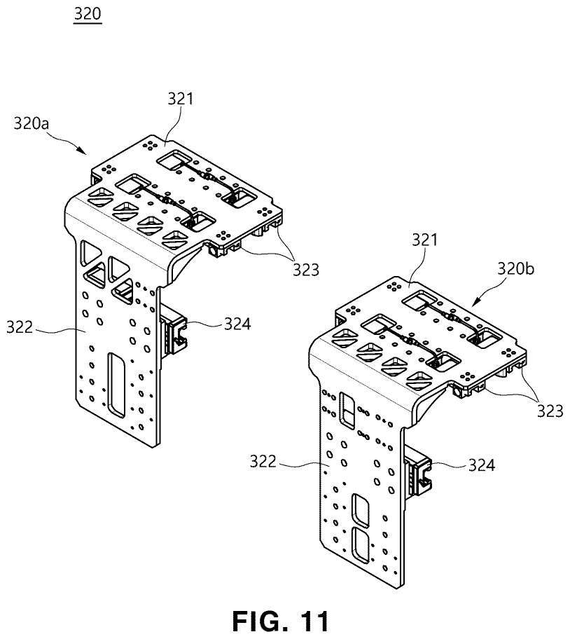

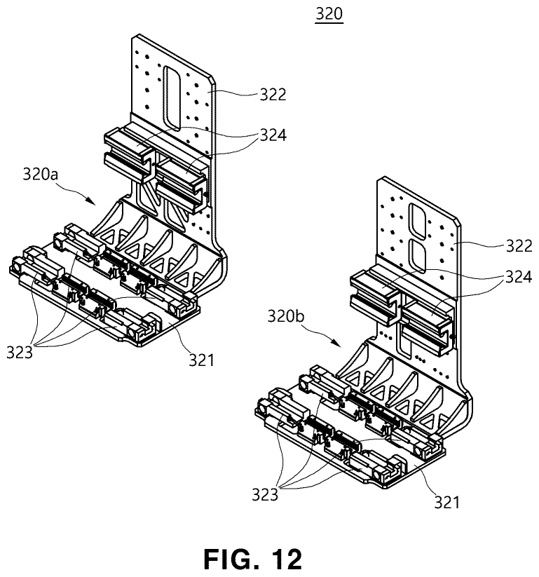

In the embodiment shown in FIGS. 11 to 12, the housing coupler 320 is provided in a pair, including a first housing coupler 320a coupled to the first arm 310a and a first wheel 330a, respectively, and a second housing coupler 320b coupled to the second arm 310b and a second wheel 330b, respectively.

The first housing coupler 320a and the second housing coupler 320b are movably coupled to the housing 200, respectively. In this case, the first housing coupler 320a and the second housing coupler 320b may be moved independently of each other. In addition, the first housing coupler 320a and the second housing coupler 320b may be moved in a direction toward each other and in a direction opposite to each other.

In the embodiment shown in FIGS. 11 to 12, the housing coupler 320 includes a first plate 321, a second plate 322, a first guide clamp 323, and a second guide clamp 324.

The first plate 321 forms one portion of the housing coupler 320. In the illustrated embodiment, the first plate 321 forms an upper surface of the housing coupler 320. The first plate 321 is disposed to cover one surface of the housing 200, i.e., an upper surface in the illustrated embodiment.

The first plate 321 is continuous with the second plate 322 at a predetermined angle. In the illustrated embodiment, the front side end of the first plate 321 is continuous with the upper side end of the second plate 322. In an embodiment, the first plate 321 and the second plate 322 may be vertically continuous. The predetermined angle may be changed according to an angle between an upper surface and a front side surface of the housing 200.

The first guide clamp 323 is positioned on one surface of the surfaces of the first plate 321 toward the housing 200, i.e., on the lower surface in the illustrated embodiment.

The first plate 321 may have any shape capable of being continuous with the second plate 322, being coupled to the first guide clamp 323, and covering an upper surface of the housing 200. In the illustrated embodiment, the first plate 321 has a polygonal cross-section and is formed in a polygonal plate shape having a thickness in the up-down direction.

The second plate 322 forms the other portion of the housing coupler 320. In the illustrated embodiment, the second plate 322 forms a front side surface of the housing coupler 320. The second plate 322 is disposed to cover the other surface of the housing 200, i.e., a front side surface in the illustrated embodiment.

The second plate 322 is continuous with the first plate 321 at a predetermined angle. As described above, the predetermined angle may be a right angle.

The second plate 322 is coupled to the arm 310. The second plate 322 may be coupled to the coupling plate 312 of the arm 310.

The second plate 322 is coupled to the wheel coupler 330. The second plate 322 may be coupled to wheel coupling plate 332 provided in the wheel coupler 330.

Therefore, it may be said that the housing coupler 320 mediates the coupling between the arm 310 and the wheel coupler 330.

The second guide clamp 324 is positioned on one surface of the surfaces of the second plate 322 toward the housing 200, i.e., on the rear side surface in the illustrated embodiment.

The second plate 322 may be any shape capable of being continuous with the first plate 321, being coupled to the second guide clamp 324, being coupled to the coupling plate 312 and the wheel coupling plate 332, and covering the front side surface of the housing 200. In the illustrated embodiment, the second plate 322 has a quadrangular cross-section and is formed in a quadrangular plate shape having a thickness in the front-rear direction.

The first guide clamp 323 is movably coupled to the first guide rail 231. In an embodiment, the first guide clamp 323 may be coupled to the first guide rail 231 to be slidably movable. The elevator 300 may be moved by the coupling in the longitudinal direction, that is, in the left-right direction of the housing 200.

The first guide clamp 323 is positioned on one surface of the surfaces of the first plate 321 toward the housing 200, i.e., on the lower surface in the illustrated embodiment.

A plurality of first guide clamps 323 may be provided. The plurality of first guide clamps 323 may be disposed in parallel to each other along the longitudinal direction of the housing 200. In the embodiment shown in FIG. 12, two first guide clamps 323 are provided and disposed side by side in the left-right direction.

The first guide clamp 323 may be provided in a plurality of groups. The plurality of groups of first guide clamps 323 may be disposed to be spaced apart from each other along a direction in which the plurality of first guide rails 231 are spaced apart. In the embodiment shown in FIG. 12, the first guide clamp 323 is provided in a pair of groups and is positioned at the front side and the rear side, respectively.

The first guide clamp 323 located at the front side is coupled to the first guide rail 231 located at the front side. The second guide clamp 324 located at the rear side is coupled to the second guide rail 232 located at the rear side. Accordingly, the coupling of the first guide clamp 323 and the first guide rail 231 can be stably maintained.

The second guide clamp 324 is movably coupled to the second guide rail 232. In an embodiment, the second guide clamp 324 may be coupled to the second guide rail 232 to be slidably movable. The elevator 300 may be moved by the coupling in the longitudinal direction, that is, in the left-right direction of the housing 200.

The second guide clamp 324 is positioned on one surface of the surfaces of the second plate 322 toward the housing 200, i.e., on the rear side surface in the illustrated embodiment.

A plurality of second guide clamps 324 may be provided. The plurality of second guide clamps 324 may be disposed in parallel to each other along the longitudinal direction of the housing 200. In the embodiment shown in FIG. 12, two second guide clamps 324 are provided and disposed side by side in the left-right direction.

As the housing coupler 320 is movably coupled to the housing 200 by both the first guide clamp 323 and the second guide clamp 324, the coupling state of the housing coupler 320 and the housing 200 can be stably maintained. In addition, the elevator 300 may be stably moved with respect to the housing 200.

The wheel coupler 330 supports the wheel assembly 400. The wheel coupler 330 rotatably supports the wheel assembly 400.

The wheel assembly 400 may be rotated with the vertical direction as an axis while being coupled to the wheel coupler 330. Accordingly, the vehicle moving apparatus 10 may be moved in a direction of being inserted into the underside of the vehicle V or in a direction of being drawn out from the underside of the vehicle V. In addition, the elevator 300 of the vehicle moving apparatus 10 may be moved in a direction toward the wheel W or away from the wheel W The wheel coupler 330 is coupled to the arm 310. Specifically, the wheel coupler 330 is fixedly coupled to the coupling plate 312 of the arm 310.

The wheel coupler 330 is coupled to the housing coupler 320. Specifically, The wheel coupler 330 is fixedly coupled to the second plate 322 of the housing coupler 320. In this case, the second plate 322 is positioned between the wheel coupler 330 and the coupling plate 312.

Therefore, it may be said that the wheel coupler 330 is coupled to the arm 310 via the housing coupler 320.

The wheel coupler 330 is disposed to be spaced apart from the first plate 321 of the housing coupler 320. That is, as shown in FIG. 9, the wheel coupler 330 is coupled to the second plate 322 in the front-rear direction, and an upper portion (a wheel support plate 331 to be described later) thereof is spaced apart from the first plate 321. The housing 200 is inserted into a space formed by spacing the first plate 321 and the wheel support plate 331.

The wheel coupler 330 is disposed to face the arm 310 with the housing coupler 320 interposed therebetween. In the illustrated embodiment, the arm 310, the housing coupler 320, and the wheel coupler 330 are each positioned in a direction facing from the front side to the rear side, respectively.

The wheel coupler 330 is coupled to the wheel assembly 400. In the illustrated embodiment, one side opposite to the first plate 321 of each portion of the wheel coupler 330, i.e., the lower portion, is coupled to the wheel assembly 400. The wheel coupler 330 and the elevator 300 including the same are movably supported by the wheel assembly 400.

A plurality of wheel couplers 330 may be provided. The plurality of wheel couplers 330 may be provided in the plurality of elevators 300a and 300b, respectively. In the illustrated embodiment, two wheel couplers 330 are provided, including a first wheel coupler 330a positioned on the left side and a second wheel coupler 330b positioned on the right side.

The first wheel coupler 330a is coupled to the first arm 310a and the first housing coupler 320a, respectively. The first wheel coupler 330a is coupled to the wheel assembly 400 located on the left side of the plurality of wheel assemblies 400.

The second wheel coupler 330b is coupled to the second arm 310b and the second housing coupler 320b, respectively. The second wheel coupler 330b is coupled to the wheel assembly 400 located on the right side of the plurality of wheel assemblies 400.

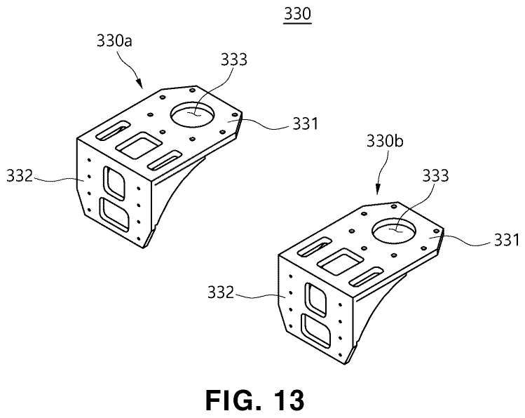

In the embodiment shown in FIG. 13, the wheel coupler 330 includes a wheel support plate 331, a wheel coupling plate 332, and a shaft through hole 333.

The wheel support plate 331 is coupled to the wheel assembly 400. The wheel support plate 331 rotatably supports the wheel assembly 400.

The wheel support plate 331 extends in the same direction as the arm body 311 or the first plate 321. In the illustrated embodiment, the wheel support plate 331 extends horizontally.

The wheel support plate 331 is continuous with the wheel coupling plate 332 at a predetermined angle. In the illustrated embodiment, the front side end of the wheel support plate 331 is continuous with the upper side end of the wheel coupling plate 332. In this case, the predetermined angle may be a right angle.

The wheel support plate 331 may have any shape capable of supporting the wheel assembly 400 and being continuous with the wheel coupling plate 332. In the illustrated embodiment, the wheel support plate 331 has a polygonal cross-section and is provided in a polygonal plate shape having a thickness in the up-down direction.

The wheel support plate 331 is disposed to be spaced apart from the first plate 321. Accordingly, an accommodation space S is formed between the wheel support plate 331 and the first plate 321. The housing 200 is accommodated in the accommodation space S.

The wheel support plate 331 supports a facing surface, that is, a lower surface of the surfaces of the housing 200. In an embodiment, the wheel support plate 331 may be coupled to the facing surface.

Therefore, even when the load of the vehicle V is applied to the arm 310, the coupling state between the elevator 300 and the housing 200 can be stably maintained.

A shaft through hole 333 is formed through the inside of the wheel support plate 331.

The wheel coupling plate 332 is a portion where the wheel coupler 330 is coupled to the arm 310 and the housing coupler 320. The wheel coupling plate 332 is coupled to the coupling plate 322 and the second plate 312, respectively. As described above, the coupling plate 312, the second plate 322, and the wheel coupling plate 332 are disposed in a direction facing from the front side to the rear side, respectively.

The wheel coupling plate 332 extends in the same direction as the coupling plate 312 or the second plate 322. In the illustrated embodiment, the wheel coupling plate 332 extends vertically.

The wheel coupling plate 332 is continuous with the wheel support plate 331 at a predetermined angle. The predetermined angle may be a right angle, as described above.

The wheel coupling plate 332 may have any shape that may be coupled with the coupling plate 312 and the second plate 322, respectively. In the illustrated embodiment, the wheel coupling plate 332 has a polygonal cross-section and is provided in a polygonal plate shape having a thickness in the front-rear direction.

The shaft through hole 333 is a portion through which a shaft (not shown) for rotating the wheel 420 of the wheel assembly 400 in a horizontal direction is penetrated. The shaft through hole 333 is formed through the inside of the wheel support plate 331 in the thickness direction of the wheel support plate 331, i.e., in the up-down direction in the illustrated embodiment.

The shaft through hole 333 may have any shape capable of rotatably supporting a shaft (not shown) penetrated therethrough. In the illustrated embodiment, the shaft through hole 333 has a circular cross-section and has a disc shape having a thickness in the up-down direction.

The shaft through hole 333 may be disposed to have the same central axis as a gear accommodating part 450 of the wheel assembly 400. In other words, the wheel 420 may be rotated clockwise or counterclockwise in a horizontal direction about the shaft through hole 333.

The wheel assembly 400 substantially performs a function of moving the vehicle moving apparatus 10. The wheel assembly 400 moveably supports the elevator 300 and the housing 200 coupled to the elevator 300.

The wheel assembly 400 supports the elevator 300 at one side of the extension direction thereof. In the illustrated embodiment, the wheel assembly 400 supports the rear side end of the elevator 300.

The wheel assembly 400 may be rotated about at least two axes.

That is, in the illustrated embodiment, the wheel assembly 400 may be rotated about an axis in a vertical direction. Accordingly, the direction in which the vehicle moving apparatus 10 is moved may be adjusted. Specifically, the wheel assembly 400 may be rotated to align in a direction toward or opposite the vehicle V, or may be rotated to align in a direction parallel to the vehicle V.

In addition, the wheel assembly 400 may be rotated about an axis in the horizontal direction. Accordingly, the vehicle moving apparatus 10 may be advanced or reversed, or the elevator 300 may be moved in a direction toward the wheel W or a direction opposite to the direction. This will be described later in detail.

The wheel assembly 400 is coupled to the elevator 300. Specifically, the wheel assembly 400 is rotatably coupled to the wheel support plate 331 of the wheel coupler 330. The wheel assembly 400 is coupled to one surface of the surfaces of the wheel support plate 331 facing the ground, i.e., to the lower side in the illustrated embodiment.

The wheel assembly 400 is not directly coupled to the housing 200. That is, the wheel assembly 400 is indirectly coupled to the housing 200 through the elevator 300. Therefore, maintenance of the housing 200, the elevator 300, and the wheel assembly 400 can be easily performed.

In addition, a separate member for rotatably coupling the wheel assembly 400 to the housing 200 is not required. Accordingly, the coupling structure of the vehicle moving apparatus 10 may be simplified, and the number of required components may be reduced, such that manufacturing costs may be reduced and manufacturing processes may be simplified.

A plurality of wheel assemblies 400 may be provided. The plurality of wheel assemblies 400 may be coupled to a plurality of elevators 300, respectively. In the illustrated embodiment, a pair of wheel assemblies 400 are provided and coupled to the first elevator 300a and the second elevator 300b, respectively.

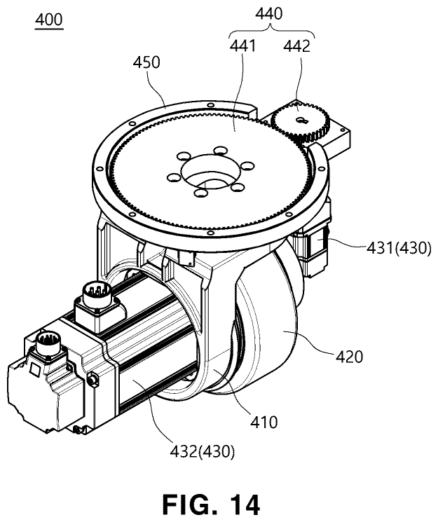

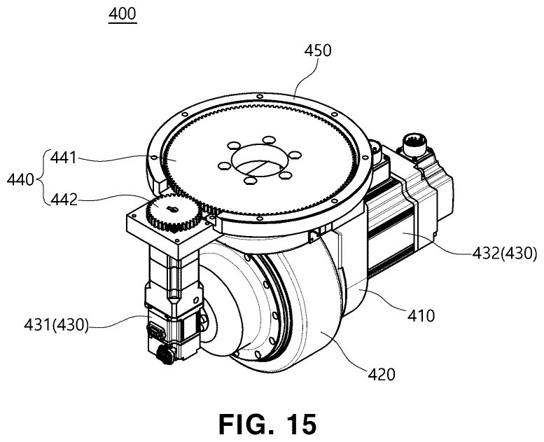

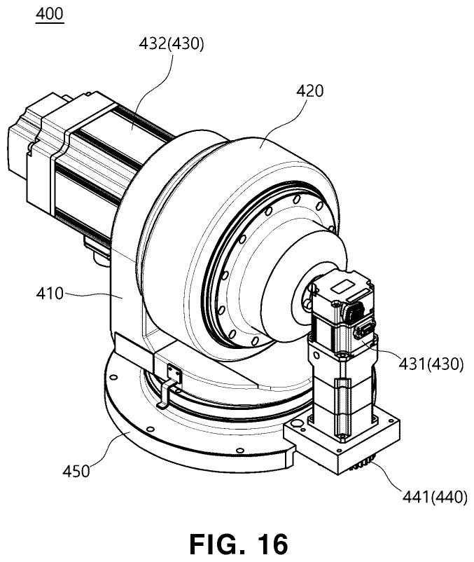

In the embodiment shown in FIGS. 14-16, the wheel assembly 400 includes a wheel housing 410, a wheel 420, an actuator 430, a gear 440, and a gear accommodating part 450.

The wheel housing 410 forms a body of the wheel assembly 400. The wheel housing 410 is coupled to and supports other components of the wheel assembly 400.

The wheel housing 410 is coupled to the wheel 420. The wheel housing 410 rotatably supports the wheel 420.

The wheel housing 410 is coupled to the actuator 430 and the gear 440. The wheel housing 410 maintains a coupling state between the actuator 430 and the gear 440.

The wheel housing 410 is coupled to the gear accommodating part 450. In the illustrated embodiment, the gear accommodating part 450 is located on one side, that is, on the upper side, of the portions of the wheel housing 410 toward the wheel support plate 331.

The wheel 420 is rotated by the power applied by the actuator 430. The wheel 420 substantially performs a function of moving the vehicle moving apparatus 10. The wheel 420 may be provided in any shape that may be rolled and moved by rotational force.

The wheel 420 is rotatably coupled to the wheel housing 410. The wheel 420 may be rotated about an axis in the horizontal direction.

The wheel 420 is coupled to the actuator 430. The wheel 420 may be rotated clockwise or counterclockwise by the power applied by the actuator 430.

The wheel 420 is coupled to the gear 440. The wheel 4209 may be rotated about an axis in a vertical direction by the gear 440.

Thus, it will be understood that the wheel 420 may be rotated with at least two different directions as axes.

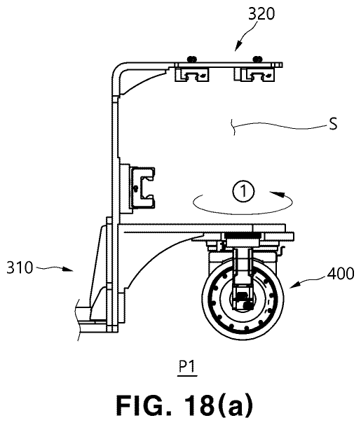

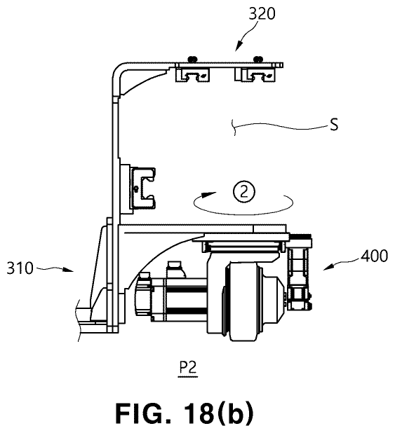

That is, as shown in FIGS. 18(a) and 18(b), when the gear 440 is operated, the wheel 420 is rotated with the vertical direction as an axis. Accordingly, the wheel 420 may be aligned in one direction between a direction toward the vehicle V and a direction parallel to the vehicle V.

When the actuator 430 is operated while the wheel 420 is aligned in a direction toward the vehicle V, the wheel 420 may be moved in a direction toward the vehicle V or in a direction opposite to the vehicle V. That is, in the above state, the vehicle moving apparatus 10 may be inserted into the underside of the vehicle V or may be pulled out of the vehicle V.

When the actuator 430 is operated while the wheel 420 is aligned in a direction parallel to the vehicle V, the wheel 420 may be moved along the vehicle V. That is, in the above state, the arm 310 may be moved toward the wheel W to lift the wheel W or may be moved away from the wheel W to place the wheel W on the ground.

In addition, the vehicle moving apparatus 10 may be moved in various directions on the ground while the vehicle V is lifted.

Therefore, the process of moving the vehicle moving apparatus 10 and lifting and lowering the vehicle V may be performed by the power provided by a single actuator 430. Accordingly, the number of components required for operation of the vehicle moving apparatus 10 may be reduced.

The actuator 430 provides power for the vehicle moving apparatus 10 to be operated. The actuator 430 is coupled to the wheel 420 and the gear 440 to provide rotational force.

The actuator 430 may be provided in any shape capable of operating the wheel 420 and the gear 440. In an embodiment, the actuator 430 may be provided as a motor. In the above embodiment, the power needed for the operation of the actuator 430 may be provided by a power source (not shown) accommodated in the housing space 210.

A plurality of actuators 430 may be provided. The plurality of actuators 430 may be coupled to the wheel 420 and the gear 440, respectively. In the illustrated embodiment, two actuators 430 are provided, including a first actuator 431 positioned at the rear side and coupled to the gear 440 and a second actuator 432 positioned at the front side and coupled to the wheel 420.

The first actuator 431 is coupled to the gear 440 to apply rotational force to the gear 440. When the gear 440 is rotated by the rotational force applied by the first actuator 431, the wheel 420 may be rotated about an axis in the vertical direction.

Accordingly, the moving direction of the vehicle moving apparatus 10 and the elevator 300 included therein may be adjusted.

The second actuator 432 is coupled to the wheel 420 to apply rotational force to the wheel 420. When the wheel 420 is rotated by the rotational force applied by the second actuator 432, the vehicle moving apparatus 10 and the elevator 300 included therein may be moved in one or more directions among a direction toward the vehicle V, a direction opposite to the vehicle V, a direction toward the wheel W, and a direction away from the wheel W

Therefore, it will be understood that the first actuator 431 provides power for adjusting the movement direction of the vehicle moving apparatus 10, and the second actuator 432 provides power required for moving the vehicle moving apparatus 10 and lifting and lowering the vehicle V.

As a result, the movement of the vehicle moving apparatus 10 and the lifting and lowering of the vehicle V may be performed by a single second actuator 432.

The gear 440 is rotated by the power applied by the actuator 430. The gear 440 is coupled to the wheel 420 to rotate the wheel 420 about an axis in a vertical direction. Therefore, it may be said that the gear 440 performs a function of adjusting the movement direction of the wheel 420.

The gear 440 is coupled to the wheel housing 410. Specifically, the gear 440 is accommodated in a space formed in the gear accommodating part 450 located on one side of the portions of the wheel housing 410 toward the wheel support plate 331, i.e., on the upper side in the illustrated embodiment.

A plurality of gears 440 may be provided. The plurality of gears 440 may be coupled to a shaft (not shown) penetrated through the shaft through hole 333 and the first actuator 431, respectively. In the illustrated embodiment, two gears 440 are provided, including a first gear 441 and a second gear 442.

The first gear 441 and the second gear 442 may be gear-fitted. When any one of the first gear 441 and the second gear 442 is rotated, the other may be rotated in the opposite direction.

The first gear 441 is coupled to the shaft (not shown). The first gear 441 receives rotational force of the second gear 442 and rotates the shaft (not shown). Accordingly, the wheel 420 coupled to the shaft (not shown) may be rotated to adjust the movement direction. That is, the first gear 441 is coupled to the wheel 420 via the shaft (not shown).

In the above embodiment, the first gear 441 may be disposed to have the same central axis as the shaft through hole 333.

The second gear 442 is positioned at the rear side of the first gear 441. The second gear 442 is coupled to the first actuator 431. When the first actuator 431 is operated, the second gear 442 may be rotated clockwise or counterclockwise. The rotation of the second gear 442 may be transferred to the first gear 441 to rotate the first gear 441 and the wheel 420 coupled thereto.

In the above embodiment, the second gear 442 may be disposed to have the same central axis as the first actuator 431.

The gear 440 is accommodated in the gear accommodating part 450.

A space is formed inside the gear accommodating part 450 to accommodate the gear 440.

The gear accommodating part 450 is coupled to the wheel housing 410. In the illustrated embodiment, the gear accommodating part 450 is located on one side, that is, on the upper side, of the portions of the wheel housing 410 toward the wheel support plate 331.

The gear accommodating part 450 accommodates the gear 440. A space is formed radially inside the gear accommodating part 450 to accommodate the first gear 441 rotatably. An opening is formed in part on the radially outside, that is, the outer circumference of the gear accommodating part 450. The second gear 442 is rotatably accommodated in the opening, and is gear-fitted with the first gear 441.

A plurality of through-holes are formed on the outer circumference of the gear accommodating part 450. A fastener (not shown) for coupling the gear accommodating part 450 with the wheel support plate 331 of the elevator 300 may be penetrated through the through hole. Therefore, it may be said that the wheel assembly 400 is coupled to the elevator 300 by the gear accommodating part 450.

The supporter 500 supports the elevator 300 at the other side of the extension direction thereof. In the illustrated embodiment, the supporter 500 supports the front side end of the elevator 300.

Therefore, the elevator 300 may stably elevate and move the vehicle V by supporting each end of the extension direction of the elevator 300 by the wheel assembly 400 and the supporter 500, respectively.

The supporter 500 is coupled to the arm 310. The supporter 500 is coupled to a coupling end 314 located at one end in the extension direction of the arm 310, i.e., at the front side end in the illustrated embodiment.

A plurality of supporters 500 may be provided. The plurality of supporters 500 may be coupled to the plurality of arms 310a and 310b, respectively. In the illustrated embodiment, two supporters 500 are provided and coupled to the first arm 310a and the second arm 310b, respectively.

In the illustrated embodiment, the supporter 500 is shown to be provided only at the front side end of the arm 310. Alternatively, a plurality of supporters 500 may be provided and disposed side by side to be spaced apart from each other along the extension direction of the arm 310. That is, in the above embodiment, the added supporter 500 may be disposed adjacent to a central portion of the arm 310 in the extension direction.

In the embodiment, since the elevator 300 and the vehicle V lifted by the elevator 300 are supported at a plurality of positions, the state can be stably maintained.

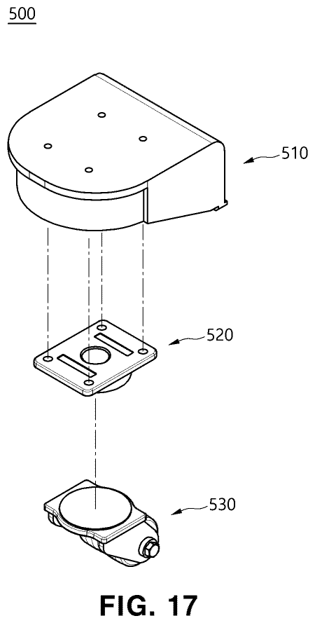

In the embodiment shown in FIG. 17, the supporter 500 includes a support body 510, a rotating plate 520, and a caster 530.

The support body 510 forms a body of the supporter 500. The support body 510 is a portion where the supporter 500 is coupled to the arm 310. The support body 510 is located closest to the arm 310 among each component of the supporter 500. In the illustrated embodiment, the support body 510 forms an upper side of the supporter 500.

The support body 510 is coupled to the rotating plate 520. One side of each portion of the support body 510 toward the rotating plate 520, i.e., the lower surface in the illustrated embodiment, may be coupled to the rotating plate 520. In an embodiment, a space may be formed inside the support body 510 to accommodate the rotating plate 520.

The support body 510 is coupled to the caster 530. As will be described later, the caster 530 is rotatably coupled to the rotating plate 520. That is, it may be said that the support body 510 is coupled to the caster 530 via the rotating plate 520.

The support body 510 may have any shape that may be coupled to the coupling end 314 of the arm 310 and may be coupled to the rotating plate 520 and the caster 530, respectively. In the illustrated embodiment, the support body 510 has a polyhedron shape: having its front side formed rounded convex outward, having other portions with a cross-section extending perpendicularly, and having a height in the up-down direction.

The support body 510 coupled to the coupling end 314 forms a front side end of the vehicle moving apparatus 10. That is, the support body 510 is inserted first into the underside of the vehicle V as the vehicle moving apparatus 10 is moved. In this case, as the front side portion of the support body 510 is formed round, the insertion process of the vehicle moving apparatus 10 may be smoothly performed.

The rotating plate 520 is coupled to the lower side of the support body 510.

The rotating plate 520 rotatably supports the caster 530. The rotating plate 520 is coupled to the support body 510. In the illustrated embodiment, the rotating plate 520 is coupled to the lower side of the support body 510.

The rotating plate 520 supports the caster 530 to be rotatable about an axis in a vertical direction. Accordingly, the caster 530 may be rotated in the same direction as the traveling direction of the vehicle moving apparatus 10, that is, the direction in which the wheel 420 is rotated about an axis in a vertical direction.

In this case, a member for limiting the rotation of the caster 530 is not provided in the rotating plate 520. That is, the caster 530 may be freely rotated about an axis in a vertical direction while being coupled to the rotating plate 520. Accordingly, the movement of the vehicle moving apparatus 10 can be performed smoothly.

The caster 530 is rotatably coupled to the rotating plate 520.

The caster 530 substantially performs a function of movably supporting the vehicle moving apparatus 10, specifically one end, i.e., the front side end, of the elevator 300 in the extension direction. The front side end of the elevator 300 is movably supported by the caster 530, and the rear side end of the elevator 300 is movably supported by the wheel assembly 400.

The caster 530 is positioned below the support body 510. The caster 530 is rotatably coupled to the rotating plate 520. Specifically, the caster 530 is coupled to the rotating plate 520 to be rotatable about an axis in a vertical direction.

The caster 530 is provided to be rotatable clockwise or counterclockwise about an axis in the horizontal direction. In this case, separate power is not provided to the caster 530.

Therefore, the caster 530 may be rotated in correspondence to the rotation of the wheel 420 to moveably support the vehicle moving apparatus 10.

Referring to FIGS. 18(a) and 18(b), a process is shown in which the wheel 420 according to an embodiment of the present disclosure is rotated to adjust the movement direction of the vehicle moving apparatus 10. As described above, the rotation of the wheel 420 is achieved by rotation of the first actuator 431 and the gear 440 coupled to the first actuator 431.

Referring to FIG. 18(a), the wheel assembly 400 is disposed at the first position P1. In the first position P1, the wheel 420 is rotated counterclockwise about an axis in the vertical direction, aligned in the extension direction of the arm 310, i.e., in the front-rear direction in the illustrated embodiment.

In the above state, the vehicle moving apparatus 10 may be moved in a direction of being inserted into the underside of the vehicle V or in a direction of being drawn out from the underside of the vehicle V.

Referring to FIG. 18(b), the wheel assembly 400 is disposed at the second position P2. In the second position P2, the wheel 420 is rotated clockwise about an axis in the vertical direction, aligned in the extension direction of the housing 200, i.e., in the left-right direction in the illustrated embodiment.

In the above state, the arm 310 supported by the wheel assembly 400 may be moved toward the wheel W to lift the wheel W or may be moved away from the wheel W to place the wheel W on the ground.

In this case, in order to be aligned to the first position P1 or the second position P2, the direction in which the wheel 420 is rotated around the vertical direction may be changed.

Referring to FIGS. 19 to 20, a process of lifting the vehicle V by the vehicle moving apparatus 10 according to an embodiment of the present disclosure is illustrated as an example.

In the embodiment shown in FIG. 19, the vehicle moving apparatus 10 is moved towards the vehicle V. At this time, the wheel assembly 400 may be aligned to the first position P1 so that the vehicle moving apparatus 10 may be moved in a direction of being inserted into the underside of the vehicle V.

As described above, the vehicle moving apparatuses 10 includes a first vehicle moving apparatus 10a and a second vehicle moving apparatus 10b. The first vehicle moving apparatus 10a and the second vehicle moving apparatus 10b may be coupled by the joint 100 and move together. In the illustrated embodiment, the first vehicle moving apparatus 10a may lift and lower a pair of wheels W located at the front side of the vehicle V. The second vehicle moving apparatus 10b may lift and lower a pair of wheels W located at the rear side of the vehicle V.

As described above, the arm 310 extends a length longer than a length in the width direction of the vehicle V. Therefore, a pair of arms 310 may simultaneously lift and lower a pair of wheels W located at the front side or a pair of wheels W located at the rear side.

A distance between each pair of arms 310 may be defined as a first distance d1. That is, the first distance d1 may be defined as a distance at which each pair of arms 310 are spaced apart when the vehicle moving apparatus 10 is moved in a state in which it is not in contact with the wheel W The first distance d1 may be defined as greater than or equal to a length of the wheel W in the diameter direction at the height of the arm 310 with respect to the ground.

In the embodiment shown in FIG. 20, the vehicle moving apparatus 10 is inserted into the underside of the vehicle V and moved toward the wheel W. At this time, the wheel assembly 400 may be aligned to the second position P2 so that the vehicle moving apparatus 10 may be moved toward the wheel W.

As described above, a pair of elevators 300a and 300b are provided in each vehicle moving apparatus 10a and 10b, respectively. The pair of elevators 300a and 300b are disposed to face each other with the wheel W interposed therebetween. When the vehicle moving apparatus 10 is sufficiently inserted into the underside of the vehicle V, the pair of elevators 300a and 300b are moved toward each other to be in contact with the wheel W.

When the movement of the pair of elevators 300a and 300b is continued, the wheel W is rolled and moved along the roller 315 and lifted upward of the arm body 311. In this case, the frictional force between the wheel W supported by the arm 310 and the arm 310 may be increased by the friction pad 316, thereby preventing arbitrary detachment of the wheel W

In the above state, a distance between each pair of arms 310 may be defined as a second distance d2. That is, the second distance d2 may be defined as a distance at which each pair of the arms 310 are spaced apart in a state in which the vehicle moving apparatus 10 may lift and lower the wheel W and the vehicle V including the wheel W The second distance d2 may be defined as less than a length of the wheel W in the diameter direction at the height of the arm 310 with respect to the ground.

Therefore, by a single power source (i.e., the second actuator 432), the vehicle moving apparatus 10 may be moved and the vehicle V may be lifted and lowered.

As described above, the vehicle moving apparatus 10 according to the embodiment of the present disclosure may be operated by a single power source.

Accordingly, the number of power sources required for operation of the vehicle moving apparatus 10 is minimized, and manufacturing costs may be reduced.

In addition, the vehicle moving apparatus 10 may be inserted into a space formed between the bottom of the vehicle V and the ground, and thus may move the vehicle by lifting the wheel W Therefore, the vehicle moving apparatus 10 can be miniaturized.

In addition, the vehicle moving apparatus 10 is configured to be inserted into and drawn out of the underside of the vehicle V. Therefore, the single vehicle moving apparatus 10 may move a plurality of vehicles V, respectively.

Although exemplary embodiments of the present disclosure have been described, the idea of the present disclosure is not limited to the embodiments set forth herein. Those of ordinary skill in the art who understand the idea of the present disclosure may easily propose other embodiments through supplement, change, removal, addition, etc. of elements within the same idea, but the embodiments will be also within the scope of the present disclosure.

<Description of Symbols>

| | |
|---|---|
| 10: | vehicle moving apparatus |
| 10a: | first vehicle moving apparatus |
| 10b: | second vehicle moving apparatus |
| 100: | joint |
| 100a: | first joint |
| 100b: | second joint |
| 110: | first joint body |
| 111: | first flange |
| 112: | first joint arm |
| 113: | first coupling hole |
| 114: | first accommodating part |
| 120: | second joint body |
| 121: | second flange |
| 122: | second joint arm |
| 123: | second coupling hole |
| 124: | second accommodating part |
| 130: | coupler |
| 131: | first coupling arm |
| 132: | second coupling arm |
| 200: | housing |
| 210: | housing space |
| 220: | joint coupler |
| 221: | first joint coupler |
| 222: | second joint coupler |
| 230: | guide rail |
| 231: | first guide rail |
| 232: | second guide rail |
| 300: | elevator |
| 300a: | first elevator |
| 300b: | second elevator |
| 310: | arm |
| 310a: | first arm |
| 310b: | second arm |
| 311: | arm body |
| 312: | coupling plate |
| 313: | reinforcing rib |
| 314: | coupling end |
| 315: | roller |
| 316: | friction pad |
| 320: | housing coupler |
| 320a: | first housing coupler |
| 320b: | second housing coupler |
| 321: | first plate |
| 322: | second plate |
| 323: | first guide clamp |
| 324: | second guide clamp |
| 330: | wheel coupler |
| 330a: | first wheel coupler |
| 330b: | second wheel coupler |
| 331: | wheel support plate |
| 332: | wheel coupling plate |
| 333: | shaft through hole |
| 400: | wheel assembly |
| 410: | wheel housing |
| 420: | wheel |
| 430: | actuator |
| 431: | first actuator |
| 432: | second actuator |
| 440: | gear |
| 441: | first gear |
| 442: | second gear |
| 450: | gear accommodating part |
| 500: | supporter |
| 510: | support body |
| 520: | rotating plate |
| 530: | caster |
| V: | Vehicle |
| W: | Wheel |
| P1: | first position |
| P2: | second position |
| S: | accommodation space |
| d1: | first distance |
| d2: | second distance |

What is claimed is:

1. A vehicle moving apparatus, comprising:
a housing extending in a first direction;
an elevator coupled to the housing to be movable in the first direction and a second direction opposite thereto, extending in a third direction and being inserted to be drawable into an underside space of a vehicle, and configured to lift or lower a wheel of the vehicle; and
a wheel assembly coupled to the elevator and configured to move the housing and the elevator in a direction toward the vehicle or in a direction opposite the vehicle,
wherein the wheel assembly comprises:
a first wheel rotatably provided with a vertical direction as an axis, and configured to movably support the elevator; and
an actuator coupled to the first wheel and configured to provide power for rotating the first wheel,
wherein the first wheel is rotatable about the vertical direction such that a diameter of the first wheel is aligned between the first direction and the third direction.

2. The vehicle moving apparatus of claim 1, wherein the actuator comprises a first actuator coupled to the first wheel and configured to provide power for rotating the first wheel about the vertical direction as an axis.

3. The vehicle moving apparatus of claim 2, wherein the wheel assembly comprises a gear coupled to the first actuator and the first wheel, and configured to deliver the power provided by the first actuator to the first wheel.

4. The vehicle moving apparatus of claim 3, wherein the gear comprises:
a first gear coupled to the first wheel; and
a second gear gear-fitted with the first gear and coupled to the first actuator.

5. The vehicle moving apparatus of claim 3, wherein the wheel assembly comprises a gear accommodating part configured to accommodate the gear and coupled to the elevator.

6. The vehicle moving apparatus of claim 2, wherein the actuator comprises a second actuator coupled to the first wheel and configured to provide power for rotating the first wheel with a horizontal direction as an axis.

7. The vehicle moving apparatus of claim 6, wherein:
The first actuator is configured to operate to rotate the first wheel about the vertical direction as an axis such that the diameter of the first wheel is aligned between the first direction and the third direction, and
The second actuator is configured to operate to rotate the first wheel about the horizontal direction as an axis such that the first wheel is movable toward the first or second direction.

8. The vehicle moving apparatus of claim 7, wherein when the first wheel rotates about the vertical direction such that the diameter of the first wheel is aligned in the third direction, the second actuator is configured to operate to insert the elevator into the underside space of the vehicle or to draw the elevator out of the underside space of the vehicle.

9. The vehicle moving apparatus of claim 7, wherein:
the elevator comprises a pair of arms extending along the third direction, and
when the first wheel rotates about the vertical direction such that the diameter of the first wheel is aligned with the first direction, the second actuator is configured to operate to move the pair of arms in a direction toward each other or a direction away from each other.

10. The vehicle moving apparatus of claim 9, wherein:
when the pair of arms are moved toward each other, the pair of arms are in contact with the first wheel, and
when the pair of arms are further moved toward each other, an outer circumferential surface of the first wheel is partially supported on the pair of arms so as to lift the first wheel.

11. A vehicle moving apparatus, comprising:
a housing extending in a longitudinal direction of a vehicle;
an elevator coupled to the housing and movable along an extension direction of the housing, and extending in a width direction of the vehicle, the elevator being insertable into or drawable from an underside space of the vehicle;
a wheel assembly positioned adjacent to a lower side of one end of the elevator in an extension direction of the elevator, and movably supporting the housing and the elevator; and
a supporter positioned adjacent to a lower side of another end of the elevator in the extension direction of the elevator, and movably supporting the elevator,
wherein the elevator comprises:
an arm extending in the width direction of the vehicle and being insertable into the underside space of the vehicle to lift or lower the vehicle;
a housing coupler coupled to one end of the arm in the extension direction of the elevator and movably coupled to the housing; and
a wheel coupler coupled to the housing coupler and rotatably coupled to the wheel assembly.

12. The vehicle moving apparatus of claim 11, wherein the arm comprises:
an arm body extending in the width direction of the vehicle;
a coupling plate positioned at one end of the arm body and extending at a predetermined angle with the arm body to be coupled to the housing coupler; and
a reinforcing rib extending along a surface of the coupling plate and coupled to the arm body and the coupling plate to maintain a coupling state of the arm body and the coupling plate.

13. The vehicle moving apparatus of claim 11, wherein the elevator comprises:
a first elevator located to be biased to one side of the housing in the extension direction of the elevator; and
a second elevator spaced apart from the first elevator in the extension direction of the housing and located to be biased to the one side of the housing in the extension direction of the elevator.

14. The vehicle moving apparatus of claim 13, wherein:
the first elevator and the second elevator are disposed to face each other with a wheel of the vehicle interposed therebetween,
when the first elevator and the second elevator are moved toward each other, the wheel is supported by the arm, and
when the first elevator and the second elevator are further moved toward each other, the wheel is lifted by the arm.

15. The vehicle moving apparatus of claim 13, wherein the arm comprises:
a first arm disposed in the first elevator; and
a second arm disposed in the second elevator,
wherein the first arm and the second arm comprise rollers disposed at respective edges facing each other and configured to be in contact with a wheel of the vehicle to be rolled.

16. The vehicle moving apparatus of claim 15, wherein:
the rollers of the first arm and the second arm are disposed in parallel to each other so as to be adjacent to each other along the extension direction of the housing, and
a length of each roller is greater than or equal to a width of the wheel.

17. The vehicle moving apparatus of claim 16, wherein:
each roller is provided in plural, and the plurality of rollers are disposed to be spaced apart from each other along the extension direction of the elevator, and
the plurality of rollers are configured to be respectively in contact with a pair of wheels of the vehicle disposed on the left side and the right side of the vehicle, respectively.

18. The vehicle moving apparatus of claim 11, wherein the arm comprises:
an arm body extending in the width direction of the vehicle; and
a friction pad positioned on an upper surface of the arm body, extending along an extension direction of the arm body, and configured to increase frictional force by contact with a wheel of the vehicle.

19. The vehicle moving apparatus of claim 18, wherein:
the friction pad is provided in plural, and the plurality of friction pads are disposed to be spaced apart from each other along the extension direction of the arm body, and
the plurality of friction pads are configured to be respectively in contact with a pair of wheels of the vehicle disposed on the left side and the right side of the vehicle, respectively.

20. The vehicle moving apparatus of claim 11, wherein the supporter comprises:
a support body coupled to another end of the arm;
a caster supporting the support body and rotatably provided with a vertical direction as an axis; and
a rotating plate positioned between the support body and the caster, coupled to the support body, and rotatably coupled to the caster.
